(19) United States
(12) Patent Application Publication
(10) Pub. No.: US 2017/0316379 A1
(43) Pub. Date: Nov. 2, 2017

(54) COMPUTERIZED SYSTEM AND METHOD FOR PROVIDING A DELIVERY SERVICE OF OBJECTS

(71) Applicant: ISRAEL AEROSPACE INDUSTRIES LTD., Lod (IL)

(72) Inventors: Hanan Lepek, Jerusalem (IL); Dani Agami, Petah Tikva (IL)

(21) Appl. No.: 15/522,009

(22) PCT Filed: Oct. 25, 2015
(86) PCT No.: PCT/IL2015/051044

§ 371 Date: Apr. 26, 2017

(30) Foreign Application Priority Data
Nov. 3, 2014 (IL) 235477

(51) Int. Cl. G06Q 10/08; B63B 27/10

(52) U.S. Cl. CPC G06Q 10/08355; G06Q 10/0834; B63B 27/10

(57) ABSTRACT

A computerized delivery service provision method, that includes providing vehicles with bays, then selecting vehicles for assignment to a resource. The selecting of a vehicle to a resource includes determining resource candidate vehicles from among the vehicles that meet a vehicle candidacy criterion, then calculating hypothetical path routes, each including a path bay and a delivery bay that are associated with the candidate vehicles, thereby obtaining hypothetical path routes for the candidate vehicles. Then, determining a best path route from among the hypothetical path routes and selecting a vehicle from the candidate vehicles that is associated with the best path route, wherein the selected vehicle will pass through the path bay terminating at the delivery bay of the best path route, for provisioning of the delivery service between the selected vehicle and the resource, and wherein the best path route involves calculated starvation time, associated with the resource, which, compared to starvation times of any other hypothetical path routes associated with the resource, meets a starvation criterion.

### TECHNOLOGICAL FIELD

The invention is in the general field of computerized objects delivery service.

### BACKGROUND OF THE INVENTION

Technological development in the fields of robotics, autonomous vehicles and computerized monitoring of processes has led to the introduction and deployment of computerized objects delivery services. For instance, there is a need to automate the process of delivering (loading/unloading) of containers to and from ships in a harbor inter alia in order to utilize in an efficient manner and reduce the idle time of expensive resources such as cranes (that load/unload the containers), considering the relatively high price tag associated with operating the cranes.

References considered to be relevant as background to the presently disclosed subject matter are listed below:

US20130103552 to Hoffman, Andrew E. et al. discloses a system and method for inventory management using mobile drive units. The method includes deploying a first mobile drive unit having first dimensions and deploying a second mobile drive unit having second dimensions, the first and second dimensions being different. The first and second mobile drive units are operable to transport inventory items to a plurality of inventory stations in the same workspace.

US20130054005 to Hoffman, Andrew E. et al. discloses a system and method for inventory management using mobile drive units. The method includes deploying a first mobile drive unit having first dimensions and deploying a second mobile drive unit having second dimensions, the first and second dimensions being different. The first and second mobile drive units are operable to transport inventory items to a plurality of inventory stations in the same workspace.

US20070294029 to D'Andrea Raffaello et al discloses a system and method for managing mobile drive units. The method for moving a mobile drive unit within a workspace includes receiving a path. The path includes at least an initial segment and one or more additional segments. The initial segment includes a portion of the path adjacent to the first point; and at least one of the additional segments includes a portion of the path adjacent to the second point. The method further includes storing the path, reserving the initial segment of the path, and moving away from the first point along the initial segment. After initiating movement along the initial segment, the method includes reserving each of the additional segments of the path and moving toward the second point along each of the additional segments while that segment is reserved.

US20070293978 to Wurman, Peter R. et al discloses a system and method for transporting inventory items. The method for transporting inventory items includes moving a mobile drive unit to a first point within a workspace. The first point is a location of an inventory holder. The method further includes docking the mobile drive unit with the inventory holder and moving the mobile drive unit and the inventory holder to a second point within the workspace. The second point is associated with conveyance equipment. The method further includes moving the inventory holder to a third point within the workspace using the conveyance equipment.

US20080001372 to Hoffman, Andrew E. et al discloses a system and method for positioning a mobile drive unit. The method for transporting inventory items includes determining an assignment state of a mobile drive unit. The method also includes selecting a location for the mobile drive unit based on the assignment state of the mobile drive unit, in response to determining that the mobile drive unit is not currently completing a task. The method further includes transmitting information to the mobile drive unit identifying the selected location. US20080167884 to Mountz, Michael C. et al discloses a system and method for fulfilling an order. The method for fulfilling inventory requests includes receiving an inventory request requesting an inventory item and selecting the requested inventory item from an inventory holder. The method further includes storing the requested inventory item in an order holder associated with the inventory request and moving the order holder to a storage space. In addition, the method includes detecting a triggering event and in response to detecting the triggering event, retrieving the order holder from the storage space.

US20080051985 to D'Andrea Raffaello et al discloses a system and method for coordinating movement of mobile drive units. A method for moving one or more mobile drive units within a workspace includes receiving, from a first mobile drive unit, a reservation request requesting use of a first path segment to move in a first direction. The method further includes determining that a second mobile drive unit is currently located on the first path segment and determining whether the second mobile drive unit is moving in the first direction. Additionally, the method includes transmitting a reservation response indicating that the reservation request is denied, in response to determining that the second mobile drive unit is not moving in the first direction. The method also includes transmitting a reservation response indicating that the reservation request is granted, in response to determining that the second mobile drive unit is moving in the first direction.

US20080051984 to Wurman, Peter R. et al discloses a system and method for generating a path for a mobile drive unit. The method of transporting inventory items includes receiving a route request from a mobile drive unit. The route request identifies a destination location within a workspace. The workspace includes at least one cell associated with a first cell attribute and at least one cell that is not associated with the first cell attribute. The method includes determining a state of the mobile drive unit. The method also includes generating a path to the destination location for the mobile drive unit that traverses cells associated with the first cell attribute, in response to determining that the mobile drive unit is associated with a first state. The method includes generating a path to the destination location for the mobile drive unit that does not traverse cells associated with the first cell attribute, in response to determining the mobile drive unit is not associated with the first state. The method further includes transmitting the path to the mobile drive unit.

Acknowledgement of the above references herein is not to be inferred as meaning that these are in any way relevant to the patentability of the presently disclosed subject matter.

There is a need in the art to provide for a new and improved system and method for providing a delivery service of objects.

### GENERAL DESCRIPTION

In accordance with an aspect of the presently disclosed subject matter, there is provided a computerized delivery service provision method, comprising
(i) providing a plurality of vehicles and a plurality of bays;
(ii) selecting vehicles of the plurality of vehicles for assignment to resources; the selecting of each vehicle with respect to a resource includes:
   1. determining, for the resource, candidate vehicles of the plurality of vehicles that meet a vehicle candidacy criterion;
   2. calculating at least one hypothetical path route associated with at least one of the candidate vehicles; each hypothetical path route including path bays, of the plurality of bays, through which the candidate vehicle would hypothetically pass and terminating at a corresponding hypothetical Estimate Time of Arrival (ETA) in a delivery bay of the bays, constituting an ETA of the hypothetical path route, for hypothetically provisioning of a delivery service between the candidate vehicle and the resource, giving rise to hypothetical path routes for the candidate vehicles;
   3. calculating hypothetical starvation times associated with the hypothetical path routes, each hypothetical starvation time, of the starvation times, defining a time interval, commencing from a resource service start time of the resource and terminating at the hypothetical ETA of the hypothetical path route, of the hypothetical path routes, and during which the resource is assumed to hypothetically wait for the candidate vehicle that is associated with the hypothetical path route, for hypothetical provisioning of a delivery service;
   4. determining a hypothetical path route from among the hypothetical path routes whose associated starvation time meets a starvation criterion and rendering the determined hypothetical path route as a best path route and selecting a vehicle from the at least one candidate vehicle associated with the best path route, for provisioning of the delivery service between the selected vehicle and the resource.

In accordance with an embodiment of the presently disclosed subject matter, there is further provided a method wherein the starvation criterion is selected from a list that includes: reducing the starvation time to a minimum, eliminating the starvation time, and starvation time falling within a predetermined starvation time interval, whether positive or negative.

In accordance with an embodiment of the presently disclosed subject matter, there is still further provided a method, wherein the starvation criterion with respect to a resource further depends upon other parameters including number of allocated vehicles vs. number of desired vehicles.

In accordance with an embodiment of the presently disclosed subject matter, there is yet further provided a method wherein further providing the following stages for execution between (i) and (ii) further comprises:

A. calculating a starvation time with respect to each of a plurality of resources; each starvation time defining a predicted time interval, commencing from a resource service start time and terminating at an estimated time of arrival (ETA) of a vehicle during which the resource is assumed to wait for a vehicle of the vehicles for provisioning of a delivery service;

B: prioritizing the resources according to a descending order of the resource starvation times with the highest priority being the worst predicted resource starvation time, giving rise to a priority list of resources; and wherein (ii) further includes selecting vehicles of the plurality of vehicles for assignment to the resources according to at least the priority list.

In accordance with an embodiment of the presently disclosed subject matter, there is yet further provided a method wherein each bay of the plurality of bays is associated with a bay state indicative of a series of temporal occupancy states of the bay and wherein the hypothetical Estimate time of Arrival (ETA) of each calculated hypothetical path route is dependent upon the bay state of each of the bays of the route.

In accordance with an embodiment of the presently disclosed subject matter, there is yet further provided a method wherein each of the temporal occupancy states is composed of at least (i) vacant state and duration or (ii) occupied state and duration.

In accordance with an embodiment of the presently disclosed subject matter, there is yet further provided a method, wherein in case that in stage (ii) (4) more than one best path route is determined, all meeting the starvation criterion, the method further comprises:

selecting a vehicle from among the vehicles associated with the more than one best route, according to a vehicle best route decision criterion.

In accordance with an embodiment of the presently disclosed subject matter, there is yet further provided a method, wherein the vehicle best route decision criterion includes at least one of the following:

(i) the selected vehicle has lower accumulated battery power compared to a non selected vehicle;

(ii) the selected vehicle is associated with a shorter best path route of the best routes that includes first number of path bays and a delivery bay, compared to a longer best path route of the path routes that includes a second number of path bays, larger than the first number and a delivery bay, and

(iii) the selected vehicle meets a “Just in Time” criterion.

In accordance with an embodiment of the presently disclosed subject matter, there is yet further provided a method, wherein the best path route is maintained even if it does no longer meet, on the fly, the starvation criterion.

In accordance with an embodiment of the presently disclosed subject matter, there is yet further provided a method, further comprising classifying the selected vehicle as a busy vehicle in response to the selected vehicle commencing to pass through a first path bay of the best pass route;

classifying the selected vehicle as a standby vehicle in response to provisioning of the delivery service between the resource and the assigned vehicle.

In accordance with an embodiment of the presently disclosed subject matter, there is yet further provided a computerized delivery service provision method further comprising:

selecting vehicles of the plurality of vehicles for assignment to resources, and for each resource per each of at least two resource service cycles;

the determining of (ii)(1), calculating of (ii)(2), calculating of (ii)(3) and determining of (ii)(4) are performed in respect of each cycle of the service cycles.

In accordance with an embodiment of the presently disclosed subject matter, there is yet further provided a computerized delivery service provision method wherein the calculating hypothetical starvation times is performed independently with respect to each service cycle.

In accordance with an embodiment of the presently disclosed subject matter, there is yet further provided a delivery service provision method, wherein the calculating hypothetical starvation time for a given service cycle is carried on to the calculated hypothetical starvation time of at least one following service cycle.

In accordance with an embodiment of the presently disclosed subject matter, there is yet further provided a method, wherein the resources are categorized into at least two types, and wherein the priority list prioritizes the resources according to the descending order in a higher priority for resources of a first type and in a lower priority for resources of a second type of the at least two types.

In accordance with an embodiment of the presently disclosed subject matter, there is yet further provided a method wherein the at least two types include crane and truck types, and wherein the first type being is crane type.

In accordance with an embodiment of the presently disclosed subject matter, there is yet further provided a method, wherein a first resource of the resources which has no vehicle, for which it is assumed to wait, has a higher priority in the priority list over a second resource for which there is a vehicle for which the second resource is assumed to wait.

In accordance with an embodiment of the presently disclosed subject matter, there is yet further provided a method, wherein the vehicle candidacy criterion is met if at least one of the following conditions is met:

the vehicle is classified as a standby vehicle state;

the vehicle is assigned to a resource already having sufficient vehicles assigned thereto;

the vehicle is assigned to a resource and will be classified as a standby vehicle state before other vehicles are classified as being in standby vehicle state;

the vehicle is of a given vehicle class; and

a vehicle has advantageous vehicle candidacy-related characteristics.

In accordance with an embodiment of the presently disclosed subject matter, there is yet further provided a method, wherein the advantageous vehicle candidacy-related characteristics include at least one of the following:

i. the candidate vehicle has lower accumulated battery power compared to a non candidate vehicle;

ii. the candidate vehicle is associated with a shorter hypothetical path route that includes first number of path bays and a delivery bay compared to a longer hypothetical path route associated with a candidate or non-candidate vehicle, wherein the longer hypothetical path route includes a second number, larger than the first number, of path bays and a delivery bay;

iii. two candidate vehicles of the candidate vehicles have identical hypothetical path route length but have better supplemental advantage selected from the group that includes a first vehicle which has less turns, or less usage of elevator bays compared to the second vehicle, or better ETA than the second vehicle;

iv. the candidate vehicle is a first vehicle in a resource Service Queue data structure.

In accordance with an embodiment of the presently disclosed subject matter, there is yet further provided a method wherein the calculating of stage (ii) (4) includes:

determining with respect to each one of the candidate vehicles a corresponding best local candidate route, of the path routes associated with the candidate vehicle, that meets a local starvation criterion, giving rise to the best local candidate routes associated with the candidate vehicles;

and wherein said determining of stage (ii) (4), further includes selecting the best path route that meets the starvation criterion from among the local best candidate routes.

In accordance with an embodiment of the presently disclosed subject matter, there is yet further provided a method, wherein the at least one of the candidate vehicles has the same vehicle class.

In accordance with an embodiment of the presently disclosed subject matter, there is yet further provided a method, further comprising:

providing, with respect to each bay of the bays, a bay state indicative of a series of temporal occupancy states of the bay;

and wherein the calculation of each of the hypothetical path routes, associated with a candidate vehicle, of stage (ii) (2) includes:

taking into account the bay state of each of the bays of the hypothetical route;

and wherein the determining a best path route of stage (ii)(4) further includes updating the temporal occupancy state of each bay of the best path route with a bay state reflecting the time duration that the selected vehicle will pass through the bay.

In accordance with an embodiment of the presently disclosed subject matter, there is yet further provided a method, wherein the bay state is representative of the point in time and duration in which the bay becomes vacant.

In accordance with an embodiment of the presently disclosed subject matter, there is yet further provided a method, wherein the bay state is representative of the point in time and duration in which the bay becomes occupied.

In accordance with an embodiment of the presently disclosed subject matter, there is yet further provided a method, wherein the bays state data structure includes:

at least two types each depending on different vehicle properties;

wherein the calculation of each of the hypothetical path routes, associated with the candidate vehicle, is dependent upon the bay state from a bay state data structure type, depending upon the candidate vehicle property;

and wherein the determining of best path route further includes updating the temporal occupancy state of each bay of the best path route in a bay state data structure type that depends upon the properties of the selected vehicle, with a bay state reflecting the time duration that the selected vehicle will pass through the bay.

In accordance with an embodiment of the presently disclosed subject matter, there is yet further provided a method, wherein the vehicle properties include (i) vehicle loaded with an object or (ii) vehicle unloaded and (iii) vehicle height.

In accordance with an embodiment of the presently disclosed subject matter, there is yet further provided a method, further comprising:

providing a bay state data structure operative to store with respect to each bay of the plurality of bays a bay state indicative of a series of temporal occupancy states of the bay; and wherein the calculation of each of the hypothetical path routes, associated with a candidate vehicle, of stage (ii) (2) includes: determining (i) a current bay of the bays which accommodates the candidate vehicle and (ii) a current or future time tag of the bay; determining at least one path bay, of the plurality of bays, that follows the current bay and a delivery bay of the plurality of bays that follows the last of the succession of path bays; for each one of the bays, determining, utilizing the bays state data structure, the hypothetical estimated time of arrival (ETA) of the vehicle to the bay is indicative of when the vehicle may utilize the bay, giving rise to the ETA of the hypothetical path route;

and wherein the determining of the best path route, associated with the selected vehicle, of stage (ii) (4) further includes:

updating the temporal occupancy state of each bay of the best path route with a bay state reflecting the time duration that the selected vehicle will pass through the bay.

In accordance with an embodiment of the presently disclosed subject matter, there is yet further provided a method, wherein the bays state data structure includes at least two types, each depending on different vehicle properties wherein the calculation of each of the hypothetical path routes, associated with the candidate vehicle, is dependent upon the bay state from a bay state data structure type, depending upon the candidate vehicle property; and wherein the determining of best path route further includes updating the temporal occupancy state of each bay of the best path route in a bay state data structure type that depends upon the properties of the selected vehicle, with a bay state reflecting the time duration that the selected vehicle will pass through the bay.

In accordance with an embodiment of the presently disclosed subject matter, there is yet further provided a method wherein the vehicle properties include (i) vehicle loaded with an object or (ii) vehicle unloaded and (iii) vehicle height.

In accordance with an embodiment of the presently disclosed subject matter, there is yet further provided a method, wherein calculating d starvation time complies with the following equation:

starvation time=(ETA−Now)−((n−1)*service time),

wherein
ETA−Now=equals the estimated time of arrival to the delivery bay minus current time,
(n−1)*service time equals the resource available time tag and wherein (n−1) equals a cycle number of the at least two resource service cycles.

In accordance with an aspect of the presently disclosed subject matter, there is yet further provided a computerized delivery service provision method, comprising:

providing a plurality of vehicles and plurality of bays;

selecting vehicles of the plurality of vehicles for assignment to a resource;

the selecting of each vehicle with respect to a resource includes:

determining for the resource candidate vehicles of the plurality of vehicles that meet a vehicle candidacy criterion;

calculating hypothetical path routes, each including at least one path bay and delivery bay of the bays, associated with at least one of the candidate vehicles; giving rise to hypothetical path routes for the at least one of the candidate vehicles;

determining a best path route from among the hypothetical path routes and selecting a vehicle from the at least one of the candidate vehicles that is associated with the best path route,

wherein the selected vehicle will pass through the at least one path bay terminating at the delivery bay of the best path route for provisioning of the delivery service between the selected vehicle and the resource;

and wherein the best path route involves calculated starvation time, associated with the resource, which, compared to starvation times of any other hypothetical path routes associated with the resource, meets a starvation criterion.

In accordance with an embodiment of the presently disclosed subject matter, there is yet further provided a method, wherein each bay of the plurality of bays is associated with a bay state indicative of a series of temporal occupancy states of the bay and wherein the starvation time of each one of the best path route and the other hypothetical path routes are dependent upon the bay state of each of the bays of the route.

In accordance with an aspect of the presently disclosed subject matter, there is yet further provided a computerized delivery service provision method, comprising:

providing a plurality of vehicles and plurality of bays;

selecting vehicles of the plurality of vehicles for assignment to resources, and for each resource per each of at least two resource service cycles;

the selecting of each vehicle with respect to a resource service cycle of the service cycles includes:

determining, for said resource service cycle, candidate vehicles of said plurality of vehicles that meet a vehicle candidacy criterion;

calculating at least one hypothetical path route associated with at least one of the candidate vehicles;

each hypothetical path route including path bays, of the plurality of bays, through which the candidate vehicle would hypothetically pass and terminate at a corresponding hypothetical Estimate Time of Arrival (ETA) in a delivery bay of the bays for hypothetically provisioning of a delivery service between the candidate vehicle and the resource at the resource service cycle, giving rise to hypothetical path routes for the candidate vehicles;

calculating hypothetical starvation times associated with the hypothetical path routes, each hypothetical starvation time, of the starvation times, defining a time interval, commencing from a resource service start time of the resource at the resource service cycle and terminating at the hypothetical ETA of hypothetical path route, of the hypothetical path routes, and during which the resource is assumed to hypothetically wait for the candidate vehicle that is associated with the hypothetical path route, for hypothetical provisioning of a delivery service at the resource service cycle;

determining a hypothetical path route from among the hypothetical path routes whose associated starvation time meets a starvation criterion and rendering the determined hypothetical path route as a best path route and selecting a vehicle from the at least one candidate vehicle associated with the best path route, for provisioning of the delivery service between the selected vehicle and the resource at the resource service cycle.

In accordance with an aspect of the presently disclosed subject matter, there is yet further provided a computerized vehicle navigation method, comprising
(i) providing a plurality of vehicles having only static sensing capacities operable to sense static surroundings associated with a plurality of bays and being devoid of dynamic sensing capacities of dynamic vehicles that are operable to utilize the plurality of bays;
(ii) dynamically determining in respect of each bay of a plurality of bays a bay state indicative of a series of temporal occupancy states of the bay, each of the temporal occupancy states is composed of at least (i) vacant state and duration during which a vehicle of the vehicles may utilize the bay or (ii) occupied state and duration during which a vehicle of the vehicles utilize or will utilize the bay;
(iii) determining at least one path route for at least one of the vehicles, wherein each path route of the path routes includes a start bay, at least one path bay and an arrival bay, of said plurality of bays; the determining in respect of each path bay including selecting the path bay out of possible bays of the plurality of bays utilizing the temporal occupancy states of the bay states of the possible bays and according to a path route criterion, thereby facilitating a vehicle of the vehicles associated with the determined path route to utilize the bays of the determined path route based on only the static sensing capabilities.

In accordance with an embodiment of the presently disclosed subject matter, there is yet further provided a method, wherein the criterion stipulates that the vehicle Estimated Time of Arrival to the arrival bay is earlier than any other hypothesized path bays that start from the start bay and end at the arrival bay.

In accordance with an aspect of the presently disclosed subject matter, there is yet further provided a computerized delivery service provision system, comprising
a plurality of vehicles configured to utilize a plurality of bays;
a processor and associated database configured to
   (i) selecting vehicles of the plurality of vehicles for assignment to resources; the selecting of each vehicle with respect to a resource includes:
      a. determining, for the resource, candidate vehicles of the plurality of vehicles that meet a vehicle candidacy criterion;
      b. calculating at least one hypothetical path route associated with at least one of the candidate vehicles; each hypothetical path route including path bays, of the plurality of bays, through which the candidate vehicle would hypothetically pass and terminating at a corresponding hypothetical Estimate Time of Arrival (ETA) in a delivery bay of the bays, constituting an ETA of the hypothetical path route, for hypothetically provisioning of a delivery service between the candidate vehicle and the resource, giving rise to hypothetical path routes for the candidate vehicles;
      c. calculating hypothetical starvation times associated with the hypothetical path routes, each hypothetical starvation time, of the starvation times, defining a time interval, commencing from a resource service start time of the resource and terminating at the hypothetical ETA of the hypothetical path route, of the hypothetical path routes, and during which the resource is assumed to hypothetically wait for the candidate vehicle that is associated with the hypothetical path route, for hypothetical provisioning of a delivery service;
      d. determining a hypothetical path route from among the hypothetical path routes whose associated starvation time meets a starvation criterion and rendering the determined hypothetical path route as a best path route and selecting a vehicle from the at least one candidate vehicle associated with the best path route, for provisioning of the delivery service between the selected vehicle and the resource.

In accordance with an embodiment of the presently disclosed subject matter, there is yet further provided a system, wherein the processor includes an outside of vehicle processor and a vehicle processor associated with each of the vehicles.

In accordance with an embodiment of the presently disclosed subject matter, there is yet further provided a system wherein the selecting, determining of (i)(a), calculating of (i) (b, calculating of (i) (c) and determining of (i) (d), are all performed by the outside of vehicle processor.

In accordance with an embodiment of the presently disclosed subject matter, there is yet further provided a system wherein the at least part of the selecting, determining of (i)(a), calculating of (i) (b), calculating of (i) (c) and determining of (i) (d), are performed at least partially by at least one of the vehicle processors.

In accordance with an embodiment of the presently disclosed subject matter, there is yet further provided a machine-readable non-transitory memory tangibly embodying a program of instructions executable by a processor for executing the aforementioned method.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A-B illustrate respective top and side views of a general layout of a robotic delivery system, in accordance with certain embodiments of the invention;

FIG. 1C is a perspective view of a multi-level structure of a storage arrangement in a robotic delivery system in accordance with certain embodiments of the invention;

FIG. 2 is a schematic perspective view of a vehicle for the robotic delivery system illustrated in FIG. 1;

FIGS. 3 and 4 illustrate two respective arrangements for supporting a shipping container above the floor in a storage arrangement, in accordance with certain embodiments of the invention;

FIG. 5 is a generalized block diagram of a robotic delivery system control, in accordance with certain embodiments of the invention;

FIG. 6 illustrates a flow diagram of a general sequence of operations of a robotic harbor, in accordance with certain embodiments of the invention;

FIG. 7 illustrates schematically a Resource Service Queue (RSQ) data structure, in accordance with certain embodiments of the invention;

FIG. 8A illustrates a flow diagram of a general sequence of operations for calculating resources' starvation time, in accordance with certain embodiments of the invention;

FIG. 8B illustrates schematically a resource starvation time vector in accordance with certain embodiments of the invention;

FIG. 9 illustrates a flow diagram of a general sequence of operations for calculating hypothetical path routes, in accordance with certain embodiments of the invention;

FIG. 10 illustrates a flow diagram of a general sequence of operations for calculating a vehicle's best path route, in accordance with certain embodiments of the invention; and

FIG. 11A-F are schematic illustrations for exemplifying a sequence of operations in a robotic delivery system, in accordance with certain embodiments of the invention.

### DETAILED DESCRIPTION OF EMBODIMENTS

Before moving on it should be noted that for clarity of explanation the robotic delivery system of the invention is described herein with reference to a specific example of a robotic harbor delivery system where containers are delivered (e.g. loaded\unloaded) to and from cranes or vehicles such as trucks. Those versed in the art will readily appreciate that a robotic harbor is only an example, a container is an example of an object that may be delivered, and a crane or truck are examples of resources. Such a system is disclosed for example in US patent application number US20120290125, the content of which is incorporated by reference. Another example is a robotic delivery system where goods (e.g. items) are transported between different workstations within a warehouse via robotic vehicles (such as carts). An item is an example of an object that may be delivered to or from a workstation (e.g. sorting station) and the robotic carts are examples of vehicles. In the latter example there are bays which form a path through which the robotic vehicle moves.

It should be also noted that whenever reference is made to a vehicle it may encompass a guided vehicle, a vehicle manned by a human operator, a partially or fully motored vehicle, a partially guided or fully autonomous vehicle, a land or airborne vehicle, etc. whichever the case may be. Note also that the vehicles are not necessarily ground vehicles and may be for example hovering/airborne vehicles or hybrid vehicles e.g. capable of ground and/or hover. The hypothetical path route and/or best path routes discussed below may be composed of bays that include ground bays or aerial trajectory sections, whichever the case may be.

Note also that in the description below, reference is made to time values in the context of various parameters such as starvation time, point in time that a bay becomes vacant or occupied, Estimate Time of Arrival (of a vehicle to a delivery bay), and others. Each of the specified time values may be as accurate as desired (e.g. measured in seconds, minutes etc) and subjected to time tolerance (e.g. T±ΔT), and, depending upon the particular applications, may have different tolerances.

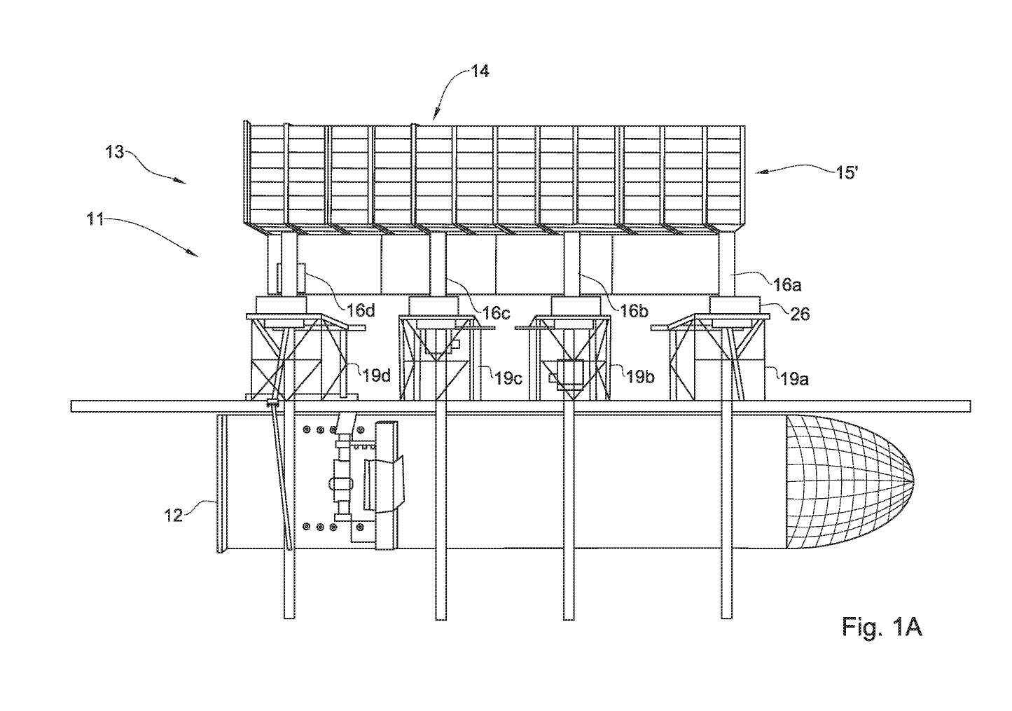

Bearing this in mind, attention is first drawn to FIGS. 1A-B, illustrating respective top and side views of a general layout of a robotic delivery system (e.g. robotic delivery harbor system) 11 accommodating a vehicle, in accordance with certain embodiments of the invention. As shown, a ship 12 docks at the quay of the harbor in close proximity to a storage arrangement 13 (e.g. robotic harbor building) that includes a plurality of bays arranged by this embodiment as a multi-level structure 14 which includes by this example 11 levels. As shown (for example with respect to the first level), each level includes a two dimensional bay array e.g. 7 (see 15′ in FIG. 1B) over 13 (see 15″ in FIG. 1A).

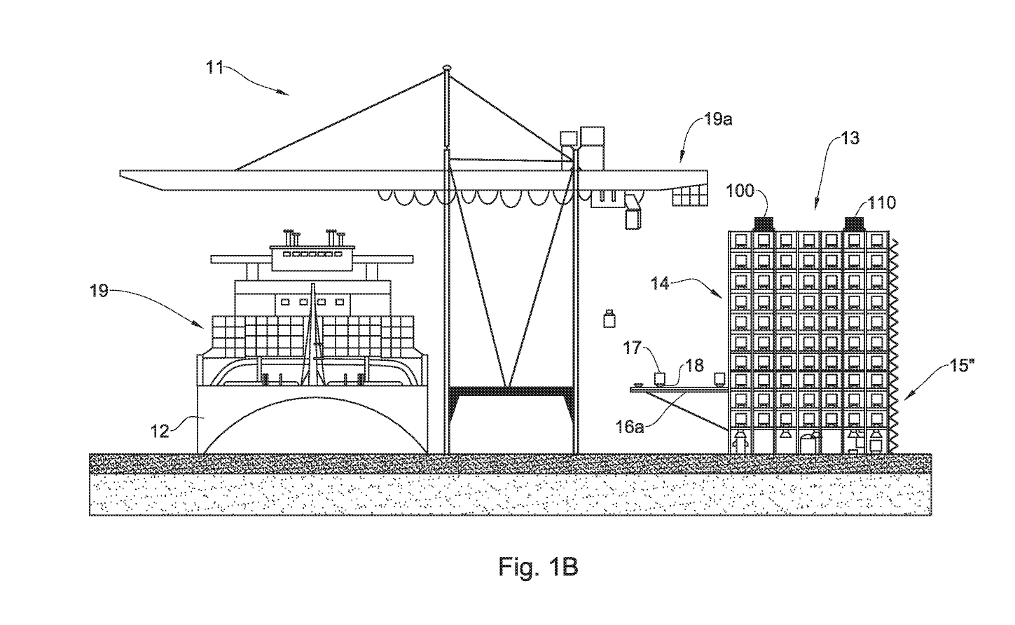

As will be explained in greater detail with reference to FIG. 2 below, the bays may temporarily accommodate containers (for instance a container per bay) that are designated to be carried by the vehicles to delivery bays of the storage arrangement 13 (e.g. balconies 16ₐ to 16_{d} in FIG. 1A, of which balcony 16ₐ is shown in the third level of the building—see FIG. 1B) for provisioning of a delivery service of containers (e.g. a container 17) between an vehicle (e.g. 18) and a resource (e.g. crane 19ₐ). Note that by this embodiment there are four resources (cranes 19ₐ to 19_{d}—see the plan view of FIG. 1A). The crane may carry the container to the docking ship 2 for stacking it e.g. in container storage area 9. By the same token, the provisioning of delivery service of objects may apply to unloading container(s) from the crane to the vehicle (not shown in FIG. 1). As will be explained in greater detail below, the vehicles are designated to pass through the bays of a given level or change levels e.g. by utilizing pass elevator bay(s) for instance elevators 100 and/or 110 that can accommodate one or more vehicles and transport them from any of the levels to the third level that accommodates the delivery bay (e.g. any of the balconies 16ₐ to 16_{d} in the third level). It should be noted that the term ‘pass’ with respect to bays may be construed as an appropriate action depending on the nature and type of the bay. Thus for example, whenever a bay represents, say, an elevator pass, the bay (or path bays) should be construed as utilizing the bay etc.

For a better understanding attention is drawn to FIG. 1C illustrating a perspective view of a multi-level structure 14 of an arrangement in a robotic delivery system in accordance with certain embodiments of the invention.

As shown, the structure 14 comprises (by this example) a plurality of levels 18, and an elevator shaft 120 spanning therebetween. The shaft may be constituted by vertically aligned gaps in each level. An elevator (bay) e.g. 110 (see also FIG. 1B), which may be open (i.e., comprising a platform configured to be moved vertically within the shaft 120), may also comprise moveable safety rails (not illustrated) configured to prevent a vehicle (not shown) thereupon from falling off, is provided to move within the shaft. (The elevator 110 is illustrated on the bottom floor of the structure in FIG. 1C.)

The shaft 120 and elevator 110 are sized such that a vehicle with a standard shipping container thereupon can be transported on the elevator to any level 18 of the structure 14. According to certain embodiments, the structure 14 may comprise more than one elevator 110.

According to certain embodiments, the shaft 120 and elevator 110 may be sized such that more than one, for example two, vehicles (not shown), each with a standard shipping container thereupon, can be transported on the elevator to any level 18 of the structure 14. According to this modification, the elevator 110 is sized such that two vehicles, each carrying a shipping container, can fit thereon when arranged adjacent to one another (i.e., the elevator is the size of two adjacent bays 124).

The standard shipping container size used to determine the size of the shaft 120 and elevator 110 may be, for example, a 20-foot container (having dimensions of 2.44 mh×2.44 mw×6.1 ml), a 40-foot container (having dimensions of 2.44 mh×2.44 mw×12.19 ml), a “high-cube” container (having similar dimensions to 20- and 40-foot containers but having a larger height, for example 2.9 m or 3.2 m), or any type of container manufactured to ISO specifications.

The levels 18 depicted in FIG. 1C which are used for storage 18a include, for simplicity, only pass bays for transferring objects (e.g. in the context of a robotic harbor-containers). However, as is shown for instance in FIGS. 1A-B, the levels include the delivery bays (e.g. 16_{A}-16_{D}) for provisioning of the containers' delivery service.

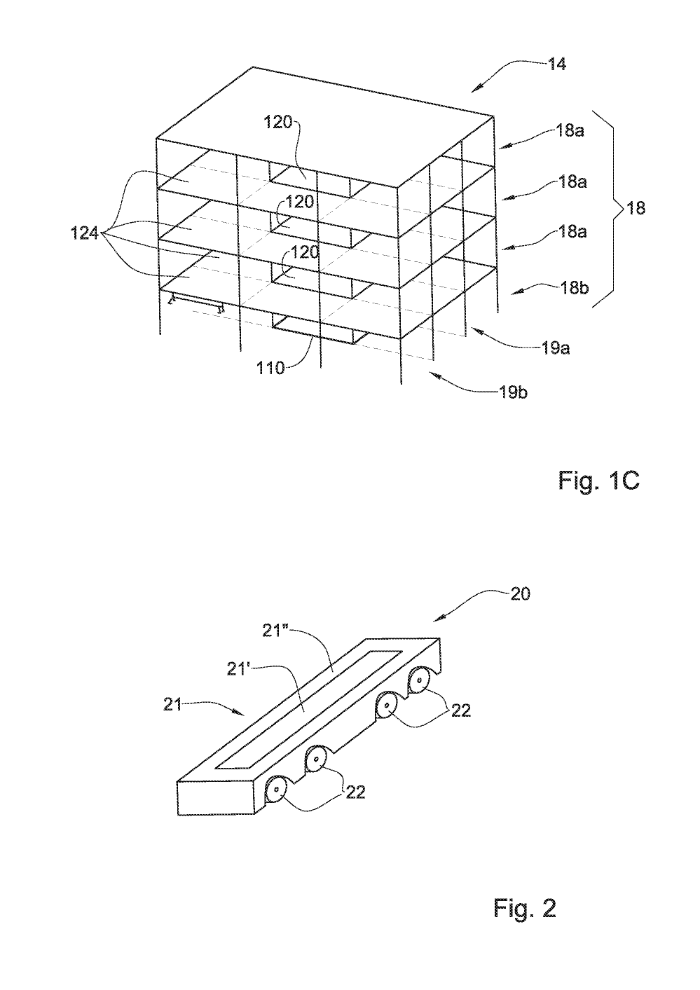

Note that the invention is not bound by at least (i) the specified storage arrangement (e.g. robotic harbor building structure) (ii) the specified multi-level structure, for instance the structure may include one level (iii) the form (e.g. array) dimensions thereof as well as the number of levels (e.g. it may consist of a single level or at least two levels) (iv) the location of the delivery bays (v) the types of the pass bays (e.g. standard bay—(e.g. 24), elevator bay (e.g. 110) and/or their structure and/or dimensions, for instance whether they can accommodate one object (such as a container) or more than one; (vi) the structure and/or dimension of the delivery bay (iv) the utilization of elevator bays and/or their locations; and so forth. Thus, by way of example, the storage arrangement may be any of those described with reference to FIGS. 3A-D and 4A-B of US patent application number US20120290125.

Turning now to FIG. 2, it illustrates a schematic perspective view of a vehicle of the robotic delivery system illustrated in FIG. 1.

Thus, each vehicle 20 comprises a flat, level body 21 (i.e., a “flatbed”) of which an inner body section 21′ can be raised relative to the outer body section 21″ and lowered until being flush with the outer body section 21″. The latter state is depicted schematically in FIG. 2 which also shows a plurality of wheels 22. The body is sized so as to receive thereon and support an object e.g. a standard shipping container. The vehicle may comprise four, six, eight, or any other appropriate number of wheels. It may be configured to move in any direction, i.e., forwards, backwards, sideways, diagonally, etc., without undergoing any rotation. In addition, it may be configured to pivot about an axis.

Each of the bays 124 may be provided with an arrangement for supporting a shipping container in a position raised above the level, while providing access to a vehicle 20 therebeneath. In addition, either the vehicle 20 or the arrangement for supporting a container (or both together) may be configured to transfer the container from the arrangement to the vehicle, and vice versa.

Thus, according to a certain embodiment, which is illustrated in FIG. 3, the arrangement for supporting a shipping container comprises a plurality, for example, four, raised supports 30 rigidly connected to the level of each bay 124. Each raised support 30 comprises an upper platform 32 supported by a leg 34. (It will be appreciated that the raised support 30 may be provided without an upper platform 32, in which case the upper platform may refer to the upper surface of the leg 34).

The supports 30 are arranged such that all the upper platforms 32 thereof can together receive and support thereon a standard shipping container. The space between adjacent legs 34 of supports 30 is sufficient to allow passage therethrough of a vehicle 20. In order to facilitate this, legs 34 may be provided only at each of the corners of the support 30, so that a vehicle 20 may pass through area 33 delimited by the legs 34 of supports 30. According to certain embodiments illustrated in FIG. 3, the height of the legs 42 is such that a vehicle 20 may enter the area 33 which extends also below the platforms 32 of supports 30 but is delimited by legs 34. Typically, a small clearance, for example e.g. of the order of a few centimeters, is allowed between the bottom edges of the platform 32 and the top of the outer body 21″ of vehicle 20. Note that the dimensions of the movable inner body 21′ of vehicle 20 are smaller than the distance between adjacent supports allowing free lifting and lowering of the inner body 21′ without colliding with the platforms 32 of the supports 30 while the vehicle is parking in area 33.

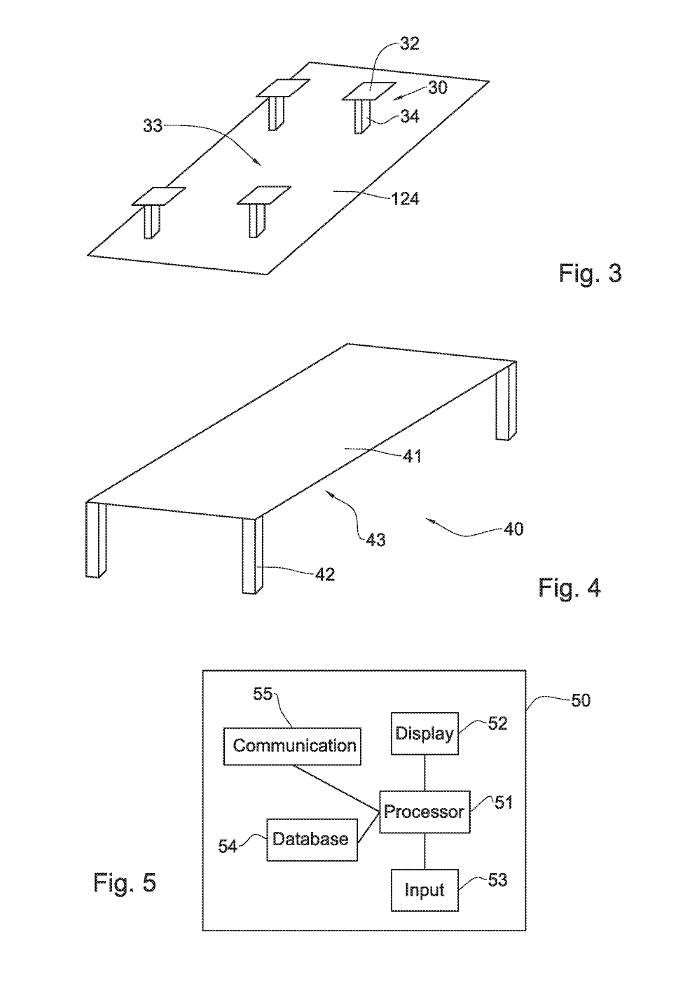

According to a certain other embodiment, which is illustrated in FIG. 4, the storage arrangement is provided with a plurality of movable supports 40. Each of the moveable supports 40 comprises an upper platform 41 supported by four legs 42. The height of the legs 42 is such that a vehicle 20 may enter the area 43 beneath the upper platform 41. Typically, a small clearance, for example e.g. of the order of a few centimeters, is allowed between bottom edges of the upper platform 41 and the top of the vehicle 20 and the legs 42 of support 40 resting aside body 21 of the vehicle 20.

According to either of the embodiments illustrated in FIGS. 3 and 4, the vehicle 20 is provided with a mechanism configured to selectively raise and/or lower the inner body 21′ thereof, thereby changing its height. In addition, the vehicle is sized so as to be able to fit within the area 33, 43 delimited by legs 34, 42 of the respective support 30, 40.

According to the embodiment illustrated in FIG. 3, a vehicle 20 with its inner body section 21′ in a raised position (above the platform level) carries a container (“loaded vehicle”) to a vacant bay (namely a bay that does not accommodate, say, a vehicle or a container), and positions itself such that the container is above the platforms 32. It then lowers inner body section 21′ (until being flush with external body 21″), such that the container is supported by the platforms 32 of supports 30 changing thus the bay's state to “occupied”. Subsequently, the vehicle 20 (now unloaded) may leave the bay. In order to retrieve the container from the bay 124 (thus changing its state to “vacant”), the vehicle performs a reverse sequence of actions.

According to the embodiment illustrated in FIG. 4, when a vehicle 20 is ready to receive a container, it positions itself under an empty support 40, raises its inner body 21′ (thus raising the support 40 off the level), and carries the support to, say, another bay (for example the delivery bay) in the storage arrangement. Once the container is loaded, i.e. it receives a container on the platform 41 of support 40 carried by vehicle 20, it proceeds to a selected vacant bay 124. The vehicle 20 lowers its inner body section 21′ (until being flush with external body section 21″), thus resting the legs 42 of the support 40 on the level and changing the status of the bay to occupied. Subsequently, the unloaded vehicle 20 may leave the bay 124, leaving the support 40 with the container thereupon in an occupied bay. In order to retrieve the container from the bay 124, the vehicle may perform a reverse sequence of actions.

In accordance with a certain other embodiment described with reference to FIG. 3, the supports 30 may be configured to be raised and lowered. They may be lowered such that the upper surface thereof is flush with the level (or close enough to the level) such that a vehicle 20 may drive over it without its movement being substantially affected thereby, or sufficient such that a container carried by a vehicle 20 may pass over it. When the container is in position over the supports 30, they raise up, thus detaching the container from the body of the vehicle (assuming that the container has larger dimensions than body 21) and rest it on the platforms 32 of supports 30. In order to retrieve the container from the supports 30, a reverse sequence of actions is performed.

According to the embodiments described with reference to FIGS. 3 and 4, each level may be provided with a small number of vehicles 20 relative to the number of bays 124 therein, and each vehicle may occupy a bay when not in use, for example a corner. In accordance with certain embodiments, and as has been discussed above, the containers are stored in a position permitting passage thereunder by an unloaded vehicle 20. Accordingly, when a vehicle is requested to receive a container at a delivery bay from a vessel resource, it may travel to the bay also through occupied bays that store containers (e.g. by passing underneath the platform 41 of support 40) thereby expediting arrival at the delivery bay and facilitating provision of the container's delivery service.

Note the invention is not bound by the specified structure of a vehicle (described with reference to FIG. 2) and/or support arrangement (described with reference to FIGS. 3, 4) which are provided for illustrative purposes only.

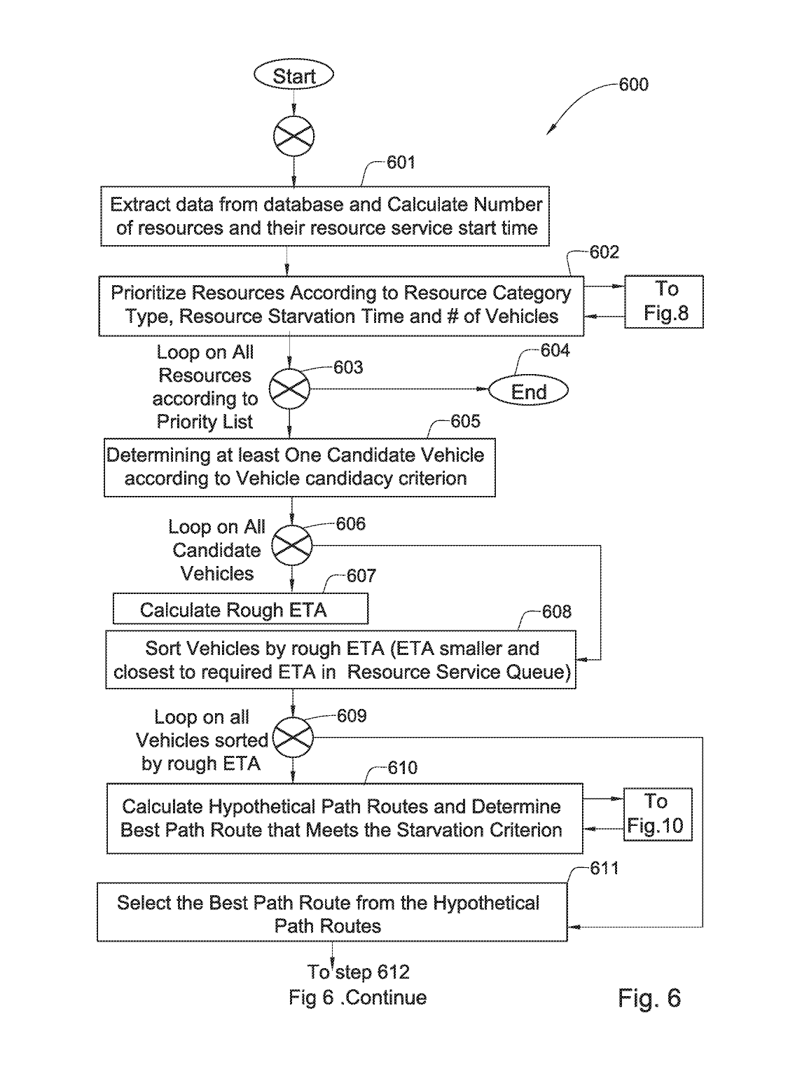

Turning now to FIG. 5, it illustrates a generalized block diagram of a robotic delivery system control, in accordance with certain embodiments of the invention.

The control system 50 is configured to communicate with the multi-level structure 14 (e.g. sensors fitted therein) and the vehicles 20. As illustrated in FIG. 5, it may include a processor 51, one or more data display units 52, and one or more user input devices 53. The data display units 52 may include one or more monitors, LEDs, speakers, audible alarms, and/or any other appropriate device. The user input devices 53 may include one or more keyboards, touch-sensitive displays, a computer mouse, microphones (for example working in conjunction with voice-recognition software), and/or any other appropriate device.

In addition, the control system 50 may be configured to store information in storage 54, for example regarding identification of containers, location of each vehicle (and thus the container it is carrying), identification/location of resources (e.g. cranes/trucks, historical data, as well as data required to control the vehicles for provisioning the delivery service between vehicles and resources, all as will be explained in greater detail below. These data may be utilized by the processor 51.

The entire control system 50 may reside near the multi-level structure 14, for example situated such that an operator thereof has an unobstructed view thereof, and may also have an unobstructed view of at least part of a path between the dock and the structure.

In accordance with certain embodiments, at least portions of the control system 50 may be located at a location remote from the multi-level structure 14. For example, the processor 51 may be constituted by a server in a remote data center. In such a case, appropriate means may be provided in the vicinity of the structure 14 for transmitting/receiving information thereto/therefrom e.g. through communication module 55. In addition, a “dumb terminal”, comprising the data display units 52 and the user input devices 53, may be provided in the vicinity of the structure 14, thereby enabling an operator to access the processor 51 while observing the operation of the rest of the system.

In addition to the above, the system of the invention may include any necessary elements/sensors (not illustrated) to facilitate its operation, such as GPS sensors, RFID (radio frequency identification) tags and reader(s), manual override and/or failsafe means, manual and/or automatic emergency shutoff means, charging/refueling stations for vehicles 20 (as appropriate, based on the type of vehicle used), etc.

Note that in accordance with certain embodiments, certain operations of control 50 may be performed by a control (not shown) fitted in the vehicles.

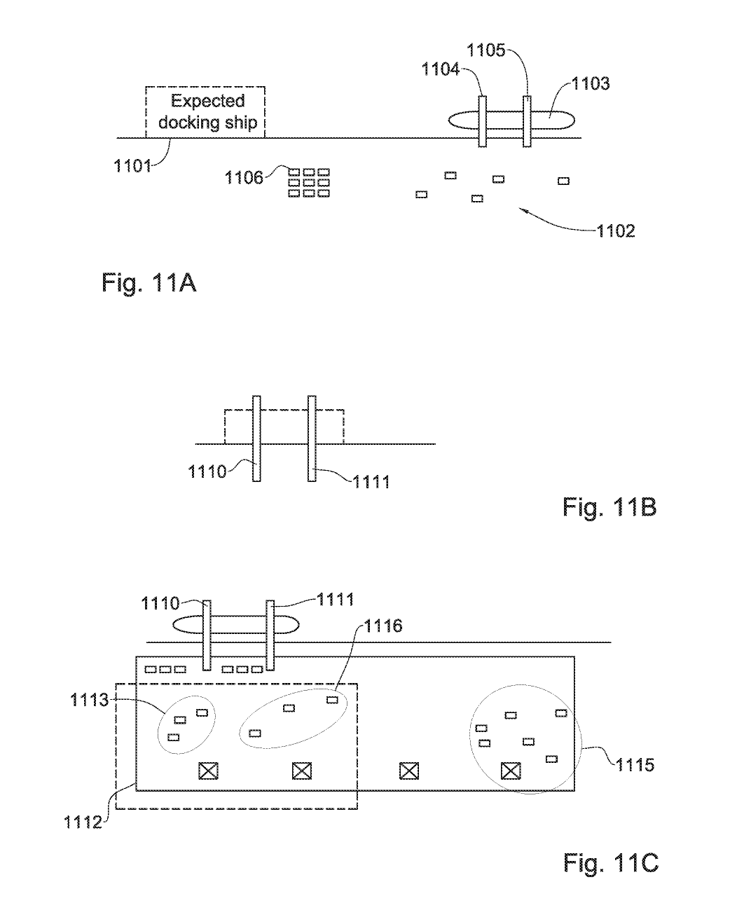

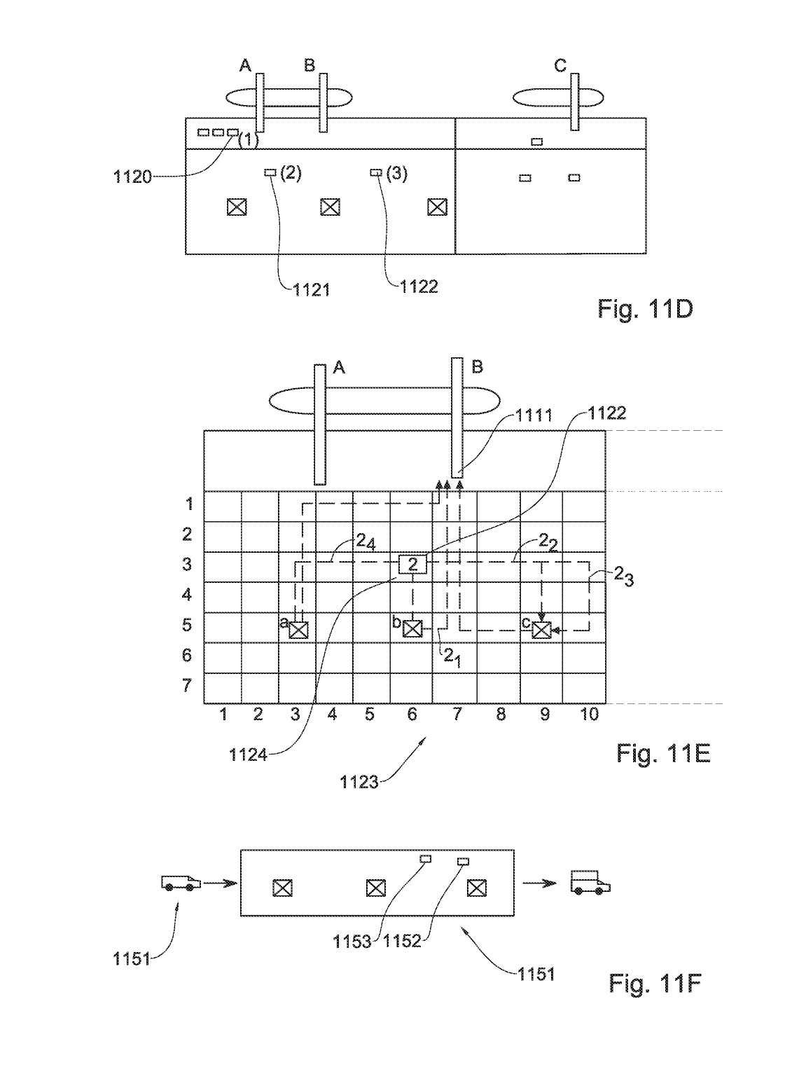

FIGS. 10 and 11 illustrate sequences of operations performed by a control system 50 for retrieving a container from a ship utilizing a crane onto a vehicle and storing it in a storage bay of multi-level structure 14 and retrieving a container from a bay in the multi-level structure 14 and transferring it to a truck. The invention is not bound by these specific exemplary sequences of operations which illustrate provisioning of a delivery (whether loading or unloading) service of an object (e.g. container) between a vehicle and a resource (e.g. a crane or truck).

As discussed briefly above, operating a resource such as a crane has a relatively high price tag and therefore it is desired to reduce or eliminate the time that the resource is in idle state. In other words, when a resource is available for service, e.g. it has retrieved or is ready to retrieve a container from a docking ship, it is desired to reduce its waiting time until the vehicle arrives at a delivery bay (e.g. balcony 16—see FIG. 1B) and the crane can deliver the container onto the vehicle. It is desired to reduce or eliminate such an undue idle wait time duration (referred to herein also as starvation time of the resource) in order to improve its operational efficiency and thereby save operational costs. More generally, the requirement is to meet a starvation criterion (for one or more resources or even one or more service cycles per resource) e.g. reduce the hypothetical starvation time to a minimum, eliminate the hypothetical starvation time, or the hypothetical starvation time falls within a predetermined starvation interval or possibly others, whichever the case may be. It should be noted that, for simplicity, the description below refers, occasionally, to reducing or eliminating the starvation extent (time). It should be noted that these are only examples of meeting the starvation criterion.

Before moving on, it should be noted that in accordance with certain embodiments of the invention, there is provided a system and method designated to determine selected vehicles and associated best path routes that include path bays (including path bays of various types e.g. an elevator bay(s) type if necessary, see below—referred to, for simplicity, as an elevator bay) of the multi-level structure and through which the selected vehicles will pass until arriving at delivery bay(s) for the provision of the delivery service(s) such that the resources (e.g. the cranes) will be most efficiently utilized, or, in other words, will meet a starvation criterion e.g. eliminate starvation time such that the crane will not wait for a vehicle to serve.

In accordance with certain embodiments, the calculation of the best path routes for the vehicles may take into account the state of the bay (e.g. whether vacant or occupied and for how long) as well as other parameters, all as will be discussed below.

A bay may be occupied e.g. by another vehicle just passing it or in a container stored therein. Note that in accordance with certain embodiments, the vehicle properties (e.g. whether or not loaded with a container, vehicle height—for instance high vehicle, low vehicle) may determine whether or not it can pass through an occupied bay.

Storage 54 may store various data that are generated or utilized by the processor in executing the sequence of operations of the various embodiments. Thus, for example, the specified data may include (not shown in FIG. 5):
The time of arrival of a docking ship or ships;
The designated quays that are associated with a crane(s);
Number of containers to upload (per ship);
Number of vehicles allocated per resource (e.g. crane);
starvation criterion. e.g. allowed starvation interval time or times per one or more resource and/or cycle(s) of crane(s);
Setting priorities between resource category types, e.g. crane has a higher priority over truck (assuming, for example, that the operational costs of a crane are significantly higher than those of a truck).

Other data that may be stored in database 54 are for example:
Resource Starvation time vector which, as will be explained in greater detail below, stores data that serves for calculating the starvation extent of the various resources (e.g. cranes) in order to properly allocate vehicles to the cranes and reduce or eliminate the resource's starvation time
Resource Service Queue (RSQ) data structure which stores data that pertains to allocation of vehicles to resources, all as will be explained in greater detail below
Bay state data structure storing, with respect to each bay, data including indications as to the bay state, e.g. vacant or occupied, all as will be explained in greater detail below
Priority list of resources, list of candidate AGCs and possibly others, all as described in further detail below.

These data may be received by transmissions through communication module 55, or for example inputted to control system 50 (e.g. default number of vehicles allocated per crane) or calculated by the processor 51, all depending upon the nature of the data. The invention is not bound by these exemplary data.

The invention is not bound by the specified data and accordingly certain data may be added and/or deleted and others may be modified. Note also that in the context of stored data, the invention is not bound by any form of storage. Thus by way of example when utilizing a given data structure, this is provided for illustrative purposes only and any known per se data structure (or structures) may be utilized. This applies to other forms of data utilized in various embodiments of the invention such as lists (e.g. priority list of resources)

Alternatively to the example shown in FIG. 5, system 50 may in some examples include fewer, more and/or different modules than shown in FIG. 5. Alternatively to the example shown in FIG. 5 the functionality of system 50 may in some examples be divided differently among the modules illustrated in FIG. 5. Alternatively to the example shown in FIG. 5, the functionality of system 50 described herein may in some examples be divided into fewer, more and/or different modules than shown in FIG. 5 and/or system 50 may in some examples include additional, less, and/or different functionality than described herein.

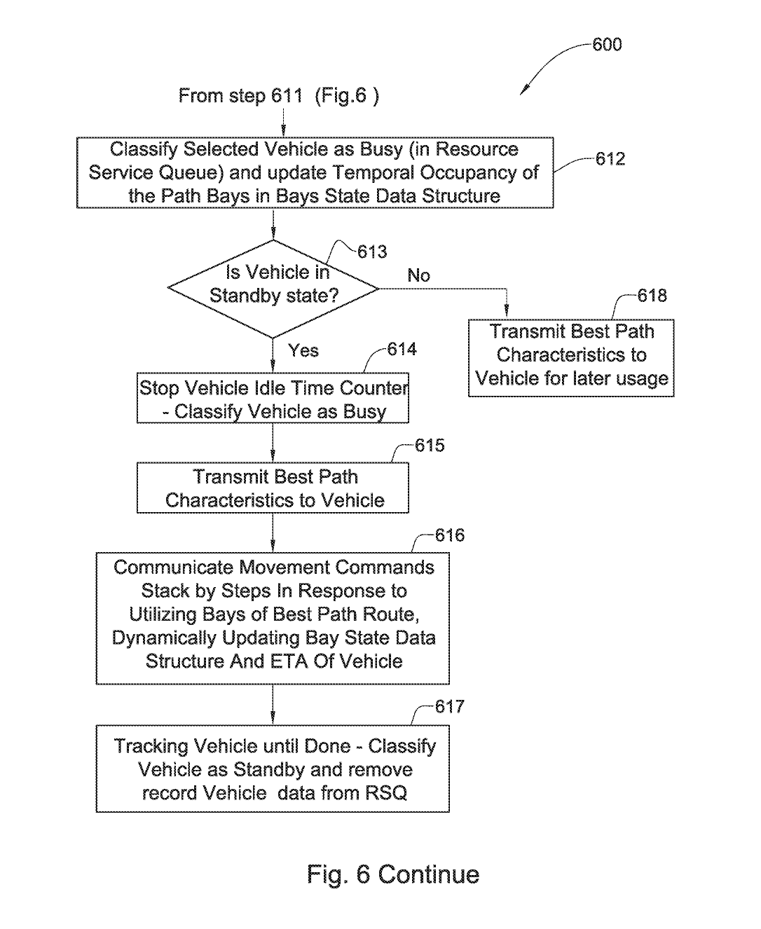

Bearing this in mind attention is drawn to FIG. 6 illustrating a flow diagram of a general sequence of operations of a robotic harbor (600), in accordance with certain embodiments of the invention. The robotic harbor is an example of a computerized system for provisioning of delivery service of objects between vehicles and resources (e.g. cranes that load or retrieve containers to/from ships).

At the onset 601, data is extracted from the database 54 to determine, for instance, the number of resources that are required for serving a docking ship, whether containers are loaded to and/or retrieved from the ship (based on the ship characteristics, e.g. size, number of containers etc), the resource category type (e.g. crane or truck) and their priority, the resource service start time indicative of the earliest time that the resource can start and serve the ship (based on the ship planned docking time, etc.), e.g. loading a container from the ship to the vehicle or unloading a container from the vehicle to the ship.

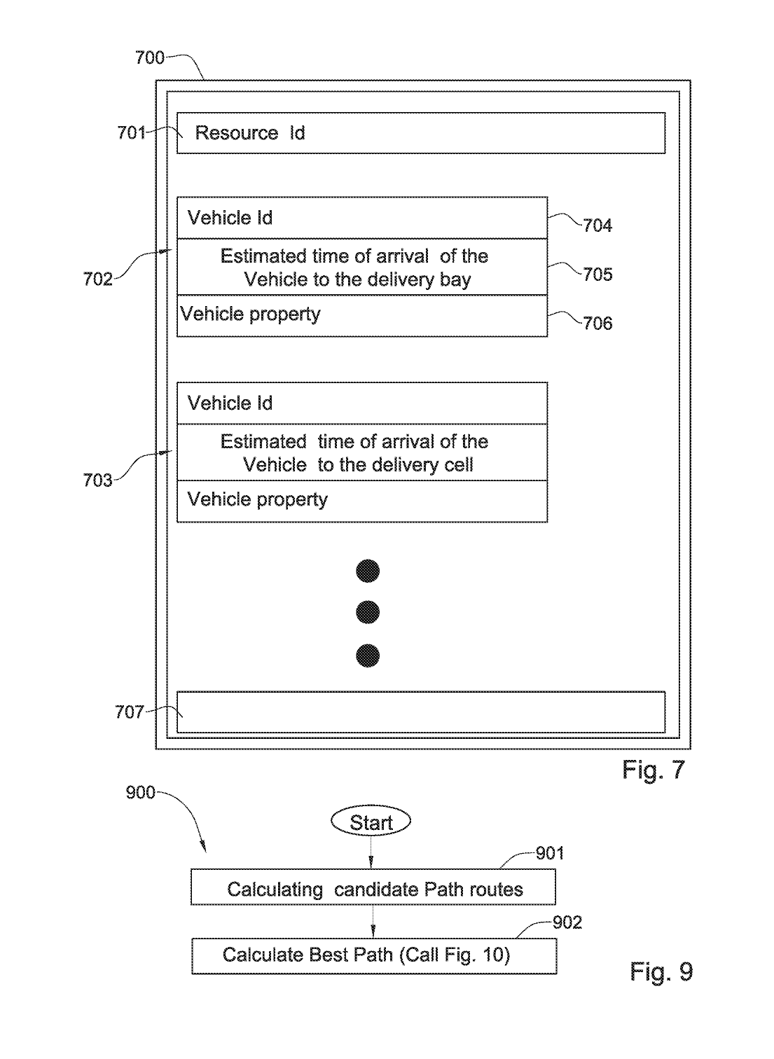

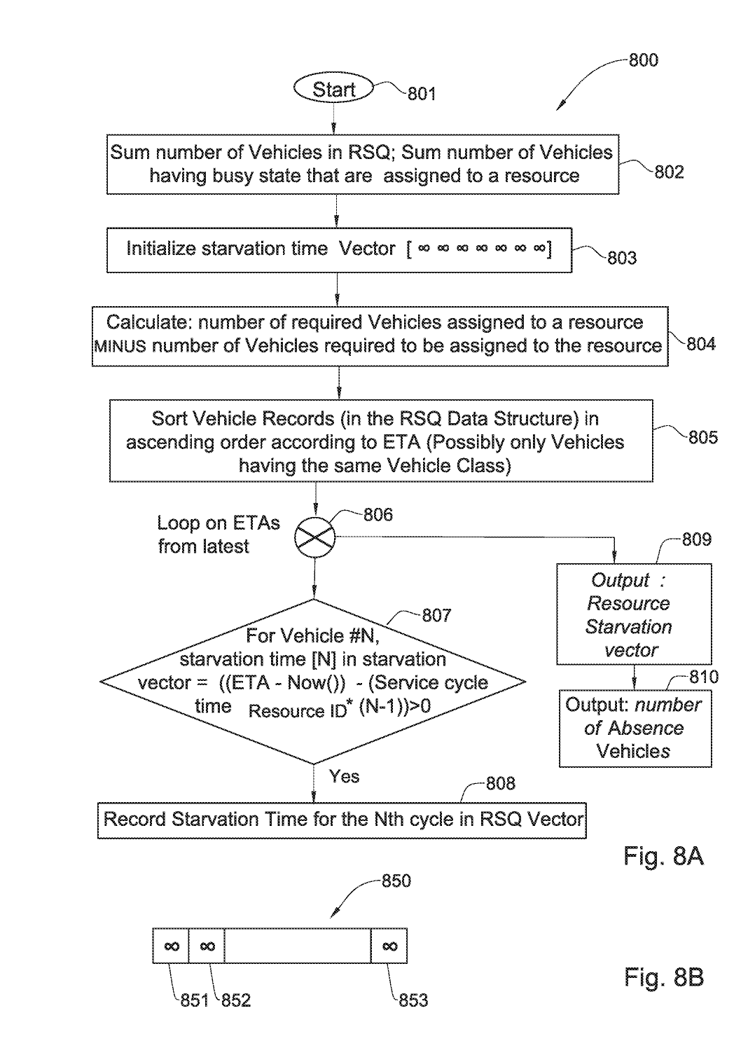

Moving on to 602, after extracting the number and possibly the identity of the resources (e.g. cranes, trucks) that are required to provide the delivery service and their type, the resources may be prioritized based on their type (for instance cranes having higher priority in delivering services over trucks). In accordance with certain embodiments, for each type, resources may be prioritized based on resource starvation time. The determination of the resource's starvation times will be described in greater detail with reference to FIG. 8. The outcome of the specified prioritization step is creation of a resource priority list which may be stored in database 54 where resources are in accordance with a certain embodiment, prioritized and based on their type and for each type e.g. in descending order, according to a resource's starvation time, with the highest priority being the worst predicted resource starvation, giving rise to a priority list of resources). The invention is not limited by these examples, and, accordingly, other parameters may indicate on starvation of resources, for instance if a resource should be assigned with X vehicles for the subsequent X service cycles (see discussion in this matter with reference to FIGS. 7 and 8 below) and is currently assigned with Y<X (i.e. it does not have a sufficient number of vehicles it may be deemed as a starving resource and duly incorporated in the priority list of resources. Another parameter that may be taken into account in prioritizing the resources is for example the following scenario: if a resource is assigned with the desired X vehicles but it has been timely served by the N^{TH} (<X) vehicle and is ready to be served by the N+1^{TH} vehicle ((N+1)<X) but is compelled to wait until the latter arrives at the delivery bay for service, it is also deemed a starving resource and included in the priority list.

The invention is not limited by the specified parameters and in accordance with certain embodiments others may be taken in lieu or in addition to at least one of the specified parameters and/or others may be added and/or various parameters that affect the priorities may be combined, depending upon the particular application.

Consider by way of example the following scenario: a resource A has a sufficient number of vehicles allocated thereto (e.g. X as obtained, for instance, from Resource Service Queue (RSQ) data structure—see 700) and suffers a starvation for the N'th vehicle, a second resource B does not have a sufficient number of vehicles (i.e. it is assigned with Y vehicles, Y<X as obtained, for instance, from Resource Service Queue (RSQ) data structure—see 700) and all the vehicles (vehicle_1, vehicle_2 . . . vehicle_Y) arrive at the required time (no starvation). Resource B is nevertheless starving “as a whole” because it has to wait for the Y+1^{TH} vehicle which has not as yet been assigned thereto. There are thus two requirements: to “find” a vehicle which can serve the first resource faster instead of the N+1^{TH} vehicle (namely reduce or eliminate that starvation of resource A due to the delay of vehicle N+1 and to reduce or eliminate the starvation of resource B by finding a vehicle that will timely arrive as the Y+1^{TH} vehicle and serve resource B.

In accordance with certain embodiments, If N<Y then resource A has a higher priority over resource B (in the priority list) considering the fact that a starvation will be encountered earlier for resource A than for resource B. If, on the other hand, N (<X) but >Y then resource B has a higher priority over resource A in the priority list since resource B will encounter starvation before resource A. The specified prioritization considerations are provided for illustrative purposes only.

As specified above, the prioritization of starvation time is important, in accordance with certain embodiments, considering the fact that when a resource (e.g. crane) is available for service, e.g. it has retrieved or is ready to retrieve a container from a docking ship, it is desired to reduce its waiting time until a vehicle arrives at a delivery bay (e.g. balcony 16—see FIG. 1B) and the crane can load the container onto the vehicle. It is desired to reduce or eliminate such an undue idle wait time duration (referred to herein also as starvation time of the resource) in order to improve its operational efficiency and thereby save operational costs.

In accordance with certain embodiments, there may be other factors/parameters, whether discussed above or others and/or combination thereof that affect the prioritization of the resources in the priority list e.g. cranes having a lesser number of vehicles assigned thereto (as obtained from Resource Service Queue (RSQ) data structure—see 700, discussed in greater detail below) compared to the number of vehicles that are required for the provision of delivery service for this particular crane.

Another non limiting example of a parameter is a command invoked by a human operator who may decide to change priorities under certain circumstances. For example, he may note that a certain truck (having a lower priority than a crane) waits too long to be served and manually imposes a delivery service for this truck before a crane which has just completed a service cycle and is ready provide service. The invention is not bound by these examples.

After having prioritized the resources, and assuming that the list is not empty, namely there are “starving” resources, they are processed 603 starting from the highest priority in descending order. If the list is empty, i.e. there are no starving resources, the process is terminated 604.

Reverting to 603, as will be evident from the following computational steps described with reference to FIG. 6, each resource is processed for assigning thereto vehicles such that its starvation time for provisioning of the delivery service (e.g. at the delivery bay—16 in FIG. 1B) will meet a starvation criterion.

Thus, and as will be discussed in greater detail below, if a given resource “starves” for provisioning of a delivery service at given service cycle (namely the Estimated Time of Arrival of a vehicle that is assigned to it, is later than the crane's service start time) an attempt is made to reduce or eliminate this starvation time by selecting a vehicle (from among candidate vehicles) that can pass through a best path route (e.g. a path route with minimal delays) and consequently have a better Estimated Time of Arrival (ETA) than the currently assigned vehicle, and if so, a vehicle is found which will “replace” (in the RSQ data structure—see FIG. 7) the previous vehicle, thereby achieving better performance and less (or no) idle time for this particular crane and for that specified service cycle. Note that the best path route is determined to meet the starvation criterion (e.g. to eliminate starvation time). The starvation criterion of the best path route obviously prevails over the starvation criteria (e.g. that fail to eliminate the starvation time) that is achieved by any other hypothetical path routes that are considered. This will be discussed in greater detail below with reference to FIG. 10.

This procedure is performed in accordance with certain embodiments with respect to every service cycle and for every resource, and is performed repeatedly to maintain efficient utilization of the resources. Note also that in accordance with certain embodiments, the specified “forced” prioritization stages are skipped and the resources are served in an arbitrary order or other paradigms such as FIFO.

Bearing this in mind and moving on to step 605, at least one candidate vehicle from among a plurality of vehicles is determined according to a candidacy criterion. At a later stage, a vehicle will be selected from among the candidate vehicles.

A vehicle's candidacy criterion may be, for example, at least one of the following:
The vehicle is classified as a standby vehicle state, namely it is not assigned to serve any resource;
The vehicle is assigned to a resource already having sufficient vehicles assigned thereto. For example a resource requires X vehicles but the Resource Service Queue (RSQ) data structure lists X+1 vehicles that are assigned to this resource and accordingly the X+1^{th} vehicle is redundant and meets the candidacy criterion a;
Consider the following example: A first ship is docking, and a second ship has not arrived as yet.
In this case there are many standby vehicles inside the building (multi-level structure 14).
There may be allocated (manually and/or automatically) more than the desired X vehicles to the docking ship—each allocated vehicle is classified as busy.
Then, if one of the cranes becomes a starving resource for a given service cycle or cycles, the redundant (busy) vehicle (i.e. the X+1^{th} vehicle) may meet the candidacy criterion and be assigned to the starving crane.
The vehicle is assigned to a resource and will be classified as a standby vehicle state before other vehicles are classified as being in standby vehicle state. This condition may be met, e.g. if the former vehicle completes delivery service to a resource before the latter vehicle completes its delivery service;
The vehicle is of a given vehicle class; as will be discussed in greater detail below, the vehicle class may depend on the object (e.g. container property). For instance, vehicle class may be all the vehicles that carry a container(s) that is (are) designated to a given destination harbor. A vehicle having advantageous vehicle candidacy-related characteristics.
Those versed in the art will readily appreciate that there may be other parameters instead of and/or in addition to those specified above for meeting the vehicle candidacy criterion. It should be also mentioned that the specified candidacy criterion may be met based on a combination of two or more parameters (e.g. of the specified parameters).

In accordance with certain embodiments, the advantageous candidacy-related characteristics may include at least one of the following:
The candidate vehicle has lower accumulated battery power compared to a non candidate vehicle;
The candidate vehicle is associated with a shorter hypothetical path route that includes a first number of path bays and a delivery bay (of the multi-level structure 14) compared to a longer hypothetical path route associated with a candidate or non-candidate vehicle, wherein the longer hypothetical path route includes a second number, larger than said first number, of path bays and a delivery bay.
Two candidate vehicles have identical hypothetical path route length, but the first vehicle (meeting the advantageous candidacy criterion) has better supplemental advantage selected from the group that includes the first vehicle has less turns, or less usage of elevator bays compared to the second vehicle, and better ETA than the second vehicle. The specified examples are by no means limiting.
The first vehicle on each RSQ (its ETA will be ETA_1+ETA_2). If it is the first, then it is just about to complete its move, and will be free within short notice (unless it was tagged as busy for next assignment immediately following this one).

Those versed in the art will readily appreciate that there may be other and or modified parameters instead of and/or in addition to those specified above. It should be also mentioned that the specified advantageous candidacy-related characteristics may be met based on a combination of two or more parameters (e.g. of the specified parameters).

Having determined a list of candidate vehicles in 605 each of the candidate vehicles is processed 606 in order to select the vehicle that will facilitate reduction or elimination of the starvation time with respect to the resource under consideration (i.e. processed according to the priority list). Note that candidate vehicles are those that are classified as “standby” but possibly also those that are classified as “busy” e.g. residing in the RSQ data structure (see discussion below with reference to FIG. 7). Thus, assume that it is required to select a best path route (and obviously an associated vehicle) to a future N^{TH} service cycle of the a given crane (now being served in the I^{TH} service cycle (where I<<N), by this embodiment not only currently “standby” vehicles may be considered, but also currently “busy” vehicles may be considered, since by the time that the N^{TH} service cycle is valid, the currently “busy” vehicles may become “standby” as they will terminate their current “busy” task.

Thus, in step 607 a rough Estimated Time of Arrival (ETA) of the candidate vehicles for serving the specified resource is calculated or obtained from the Resource Service Queue (RSQ) data structure 700.

The rough Estimated Time of Arrival may be calculated, for instance, as follows:
1) Determine the vehicle's start time as well as the current bay: determine the current bay where the vehicle is parked (e.g. after completing a previous task whereupon the vehicle's status becomes Standby) and determine the start time (initial ETA) to be the termination time of the previous task;
2) Calculate the X-Y-Z distance to the resource: namely starting from the current bay, determine the number of bays that the vehicle should pass along the X-Y dimensions of a level and the number of bays along the Z dimension (from the level of the current bay to the resource's level) and assign a given (say a default) path time duration per bay. The rough ETA would then be the initial ETA+the total path time through the X-Y-z distance.

Note that the invention is not bound by the latter example.

Then, in step 608, the candidate vehicles are sorted, with the first in the sorted list being the candidate vehicle having the smaller or closest ETA to the required ETA. The latter would be the resource's service start time, i.e. the earliest time that the resource is available for provisioning of the delivery service.

In accordance with certain embodiments the specified steps 607 and 608 are skipped and the vehicles are processed in another (e.g. arbitrary) order.

Note that the estimated ETA with respect to each candidate vehicle is only a rough estimation and in the subsequent calculating step 610 an accurate ETA is calculated based on precise (or nearly precise) estimating of the path route that the vehicle should traverse from its current parking bay until the delivery bay where the delivery service between the vehicle and the resource actually takes place.

Turning now to steps 609 and 610, the candidate vehicles are processed (e.g. according to the sorted list) in order to determine hypothetical path routes through which the candidate vehicle(s) would hypothetically pass starting from a current parking bay, moving through one or more path bay(s) (that may include e.g. elevator(s) e.g. if the vehicle changes level in the multi-level structure 14) until arriving at the delivery bay for provisioning of the delivery service between the vehicle and the designated crane (that is now being analyzed according to the resource priority list), Note that the current parking bay may be, for example, either the bay where the standby vehicle is currently parked, or, for example, the future bay (e.g. for a busy vehicle) where the vehicle will park upon termination of the current task (and will change its status from busy vehicle to standby vehicle). Note that the specified path routes are designated as hypothetical path routes because only the “best” path route from among the hypothetical path routes which meets the starvation criterion (e.g. achieves the best reduced starvation time) will be actually selected and eventually “implemented”, namely the candidate vehicle that is designated to pass through this best path route will be selected (from among all other vehicles that are assigned to the hypothetical path routes). The selected vehicle will travel through the bays of the best path route and will arrive at the delivery bay for provisioning of the delivery service. Thus, the best path route is selected and “committed” i.e. is actually used by the selected vehicle (see further discussion with reference to step 612 below) and all the calculated hypothetical path routes are “discarded” and will not be further considered. Note, however, that there may be circumstances discussed below by way of example only that lead to discarding of the best path route and allocating a new path route, which in turn will become the best path route.

Bearing this in mind, and reverting to steps 609 and 610, for each of the processed candidate vehicles, one or more such hypothetical path routes are analyzed and the hypothetical ETA of the vehicle for the respective route is determined (e.g. recorded—but not as yet “committed”—see step 612 below). Eventually, a best path route (and its associated vehicle) is selected 611 from among all hypothetical path routes of all candidate vehicles. The best path meets a starvation criterion, e.g. achieves a best hypothetical reduced starvation time associated with the resource, compared to the hypothetical reduced starvation time associated with the resource that is achieved by any other hypothetical path routes. In accordance with certain embodiments, the best reduced starvation time eliminates the starvation time such that the resource does not need to wait in idle state until the vehicle is ready for the delivery service.

The specified starvation criterion may be for example an elimination of the hypothetical starvation time, hypothetically reducing it to a minimum, or hypothetically falling within an allowed starvation interval etc.

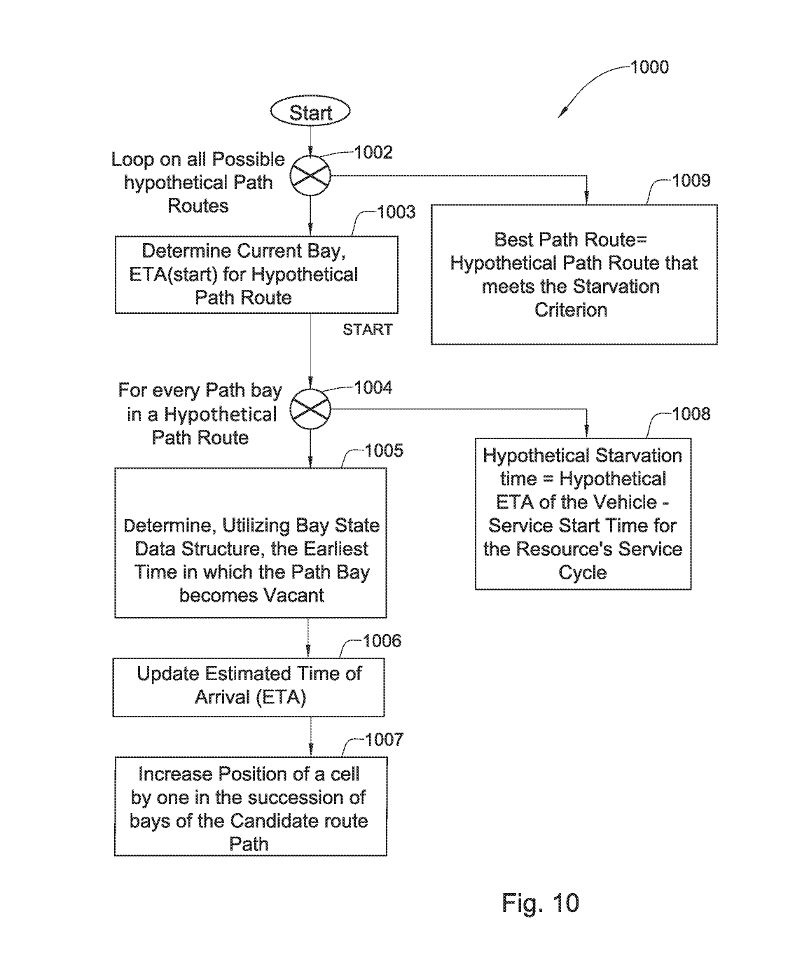

The sequence of operations for determining the best path route and selection of vehicle will be described in greater detail with reference to FIGS. 9 and 10 below.

As will be evident from the description below with reference to FIGS. 9 and 10, the determination of the candidate path routes may take into account the state of the bays, e.g. whether vacant or occupied, and utilize the bay state data structure.

In case more than one best path route is determined, e.g. there are two or more best path routes, all achieving the best reduction or elimination of starvation time, one of them is selected according to a vehicle best route decision criterion.

In accordance with certain embodiments, the vehicle best route decision criterion includes at least one of the following:
(i) the selected vehicle has lower accumulated battery power compared to non selected vehicle;
(ii) the selected vehicle is associated with a shorter best path route of said best routes that includes first number of path bays and a delivery bay, compared to a longer best path route of the path routes that includes a second number of path bays, larger than the first number and a delivery bay, and
(iii) meeting a “Just in Time” criterion, e.g. when two best path route achieve a starvation criterion where both eliminate the starvation time of a resource for a given service cycle, but a vehicle associated with the first best path route hypothetically arrives at the delivery bay X time units (e.g. seconds) before the resource is available for service, whereas the vehicle of the second “best path route” hypothetically arrives Y time units (e.g. seconds) before the resource becomes available for service, and further assume that Y<X, then the second path route meets the specified best path route criterion because its associated vehicle arrived just in time (namely has lesser wait “idle” time) compared to the arrival time of the vehicle of the first path route because the latter (due to its earlier arrival time) is compelled to wait a longer time before the resource becomes available.
(iv) The selected vehicle passes through a best path route having advantageous best path route characteristics (e.g. lesser number of turns) than the other best path routes.

Note that the invention is not bound by the specified conditions and accordingly modified and/or other(s) may be added instead or in addition to the specified conditions.

As shown in step 612, once a vehicle is selected (having an associated best path route), the vehicle's data may be updated (i.e. committed) whereas the data that pertains to all the other hypothetical path routes may be discarded. Thus, in accordance with certain embodiments, the Resource Service Queue (RSQ) data structure 700 is updated (e.g., vehicle Id, its calculated Estimate Time of Arrival to the delivery bay through the best path route, and others—see discussion later with reference to FIG. 7 below).

The vehicle is marked as busy in the RSQ or, if desired, in a different data structure (not shown), and a so called bay state data structure is updated. The bay state data structure stored with respect to each of the bays (e.g. 124 of FIG. 1C), is a bay state indicative of a series of temporal occupancy states of the bay. Thus, in accordance with certain embodiments, the bay state of the bays that constitute the best path route may be updated with a temporal occupancy state that corresponds to the point in time and duration that the bay will become occupied (which is the time that the selected vehicle traveling through the best path route is planned to arrive and pass this bay). The update of the temporal occupancy states of the bays state data structure will be further discussed with reference to FIGS. 10 and 11 below.

Note that the specified representation of temporal occupancy, namely start time and duration that the bay is occupied is an example only and other representations may be applicable, for example the point in time and duration that the bay is vacant. Another example is point in time and duration that the bay is inactive (e.g. undergoing maintenance), etc. Note also that the specified temporal occupancy state may depend on various scenarios, for instance, a bay of a given type may accommodate two vehicles simultaneously and thus in case a given vehicle passes through the bay, its status may still be “vacant” facilitating a path of another vehicle at substantially the same time. Note incidentally that in accordance with certain embodiments there may be bays of distinct (and possibly different) types.

The update of the RSQ data structure and the bay's state data structure are only examples of such a commit action, and depending on various embodiments, modification of the specified data may be updated and/or other data taken into consideration, depending upon the particular application. This will be discussed in greater detail with reference to FIGS. 9 and 10, below. Other data may be updated, all as required and appropriate.

Moving on to step 613, an inquiry is made whether the vehicle is busy or in standby state. In the latter case it is classified as busy 614. Note, incidentally, that in accordance with certain other embodiments the vehicle may have also additional states such as e.g. at least one of charging, Failure, Unloading/Loading, that may be utilized, depending upon the particular application.

Then, the best path route characteristics (e.g. the path bays and their traversal time) are transmitted 615 to the vehicle for storage and use by processor and storage.

Other data may be transmitted, such as container type, container id, container weight, destination bay and/or destination resource, etc.

The vehicle commences to move through the bays 616 according to the best route plan and pass each path bay (which may include e.g. an elevator) at the designated timing. This will be exemplified for clarity with reference to FIG. 11.

Upon arrival at the delivery bay and providing the delivery service, the vehicle is classified again as standby 617, and the record representative of the specified vehicle is removed from the RSQ data structure.

Consequently the ETA of the vehicle to the delivery bay may be updated (e.g. in the RSQ data structure). This may trigger detection of a starvation time, all as will be discussed in greater detail with reference to FIG. 8 below.

Reverting now to inquiry 613, in case the vehicle is busy (618), the best path route characteristics (e.g. the path bays and their vacancy time data) are transmitted to the vehicle and will be timely used when the vehicle becomes a standby vehicle (through steps 614 to 617).

Note that when the vehicle terminates its current mission it will become available again (its state is changed to Standby) and when it is selected and assigned to a best path route of a future task (as described in detail above) its state will become busy again.

Note that the specified determination of a vehicle's best path route for meeting the starvation criterion of the resource may be applied with respect to each service cycle of the resource, e.g. it is desired to reduce or eliminate the starvation time of the resource with respect to every service cycle thereof.

Note that the execution time of the control system in accordance with the computational steps described with reference to various embodiments of the invention may be of the order of a fraction of a second. During this relatively short time interval, best path routes are determined and vehicles are selected for passing through the best path routes in order to provide delivery services to resources during a succession of resource service cycles whilst meeting the starvation criterion e.g. keeping predicted resource's starvation time to zero, or close to zero. In contrast, actual implementation of this scheme in the robotic harbor i.e. the selected vehicles moving along the specified path routes at the proper timing and the provisioning of the delivery services of the containers between the vehicle and the resources (whether loading or unloading of containers) is of the order of minutes, or even tens of minutes per service cycle. It thus readily arises that if everything works as planned (e.g. no interruption occurred from the user end, no error was made by the crane operator, no malfunction is encountered in any of the selected vehicles etc.), then the so determined best path routes may be actually implemented and the starvation time of the resources for every resource cycle may be kept to zero or nearly zero. Under these circumstances, and in accordance with the embodiment of FIG. 6, further execution of all the steps following 602 are obviated because there is no need to modify the so calculated plan that assigned vehicles to the resources, such that the resource's starvation time for every resource service cycle is minimal. The specified sequence of operations (steps 602 and onwards) may be invoked again in case of, for example, an event that disrupts the optimal operation of the robotic harbor and consequently a starvation time is generated with respect to at least one service cycle of at least one resource. This starvation event will be encountered (e.g. in step 807 discussed in greater detail below) and will eventually trigger the operation of the computational steps of FIG. 6 to rectify the situation and to reduce or eliminate the so revealed starvation time. This may require calculating of one or more new best paths, different assignment of one or more of the vehicles to one or more service cycles with respect to at least one resource, all as required and appropriate. Thus, by way of example, if an elevator which a vehicle is supposed to use gets stuck, or, due to intervention by a human operator, it is used for something else, then the ETA for this bay is updated (in step 616) which obviously delays the ETA of arrival to the delivery bay later than planned, thereby generating a starvation (which will be revealed in step 807 of FIG. 8, see discussion below). The starvation will trigger determination of best path (executing the computational steps of FIG. 6 among hypothetical path routes as discussed above) with possibly identifying another vehicle with an ETA that copes with the so encountered starvation, thereby “updating” the operation on the fly. Note that in certain embodiments if the currently assigned vehicle encountered delay (due to, say, malfunctioning delay) it may nevertheless carry on the mission notwithstanding the delay (and possibly no longer meeting the best path route condition). This may occur for instance if there are not enough vehicles, or if the vehicle already carries a container that has to be delivered to the crane for loading onto the ship. Other scenarios are applicable depending upon the particular application. The latter is an example of a condition for maintaining the best path route even if it does no longer meet, on the fly, the starvation criterion.

This may be implemented for instance in step 603 where no other candidate vehicle is found with lower priority to replace the specified vehicle and thereafter moving to step 604 (end), with the consequence that the current vehicle is retained in its mission.

Note also that in accordance with certain embodiments, if the operation of the control 50 does not converge to eliminate the resource's starvation times or starvation time of one or more resources for one or more service cycles is frequently encountered, then an additional vehicle or vehicles may be added to the existing fleet in order to cope with this problem.

In certain embodiments, when an event is encountered but to the extent that no starvation is encountered, the sequence of operations e.g. in steps 610 and onwards is invoked. Thus, for example, if a temporal occupancy state (or states) in a series indicates that a given bay (of the so determined best path route—discussed above) is occupied from a certain point in time and for a given duration, and it turns out that these data are not in agreement with the actual time of arrival of the vehicle to the bay and/or the traversal time duration through the bay (e.g. a vehicle's ETA to a given bay is delayed or preceded [due to the event] by say X time units) then the re-invoking the specified steps 610 and onwards will rectify the bay state data structure to reflect updated series of temporal occupancy state(s). Consider for example a vehicle that is designated to arrive to a delivery bay at an ETA that is earlier by say 5 seconds than that of the desired service time at a given service cycle. If due to an event a 2 seconds delay occur to a given bay that leads to a less than 5 seconds delay at the delivery bay, no starvation is encountered but still the temporal occupancy states are not updated and accordingly invocation of steps 610 may result in updated bay state data structure. The utilization of steps 610 and onwards is of course an example. X by the latter example may be determined depending upon the particular application.

While the description with reference to FIG. 6 referred to determination of a best path route of an vehicle traveling to a delivery bay, the same holds true mutatis mutandis for a vehicle traveling from the delivery bay (e.g. loaded with a container that was retrieved from a ship) toward a different destination, e.g. a delivery bay for loading the container on the truck or storing the container at a designated bay or location in or in association with the multi-level structure.

Turning now to FIG. 7, this illustrates schematically a Resource Service Queue (RSQ) data structure 700, in accordance with certain embodiments of the invention. Thus, the RSQ (which may be stored in database 54) includes indications of resource (e.g. crane) vehicles assigned thereto. By this embodiment, it includes resource ID 701 and, with respect to the resource, a list of records indicative of assigned vehicles, according to their service order. Thus, record 702 is representative of the first vehicle that is designated to provide (or is provided with) the delivery service with respect to the resource. The vehicle (of record 702) may for example load a container(s) to the crane or may unload a container from the crane at the delivery bay of the building 14. The next record 703 is representative of another vehicle assigned to the same resource (and which will be delivering the service after the first vehicle has finalized its task), and so forth until the N^{th} record 704 representative of the last vehicle that is assigned to the resource. The data with respect to this vehicle (e.g. record 702) includes by this example the following fields: vehicle's id 705, the Estimated Time of Arrival (ETA) of the vehicle to the delivery bay 70 and possibly other properties 707 such as vehicle class. The vehicle class may be determined based on various parameters such as, for example, the destination harbor and/or weight range (e.g. light container or heavy container). The latter are merely non limiting examples of container parameters and others may be added instead of or in addition to the specified parameters. The utilization of vehicle class which depends upon e.g. container parameters, will be exemplified with reference to FIG. 8 below.

Note that the data that pertains to the vehicles assigned to a given resource may be a priori stored and extracted for later use (in step 601).

Note also that the RSQ data structure may be updated dynamically in accordance with meeting a certain criterion in terms of the number of vehicles that are assigned to a given resource. Thus, for example, the number of vehicles in the RSQ for a given resource may be determined e.g. in accordance with the desired Quality of Service. Consider, for example, for a given ship, having e.g. hundreds of containers for retrieval, it may be determined that the RSQ contains 7 vehicles for securing in advance that vehicles are assigned for provisioning of container delivery service during each 7 service cycles, while for another container ship, for example downloading dozen thousands of containers, the rate for quantity of downloading containers per hour may be higher (due to use of a more advanced Ship to Shore Crane for the bigger ship for example or other reason), thus requiring a large buffer of vehicles for the RSQ i.e. 15 vehicles for securing a higher download and upload rate of the crane (crane productivity rate). Another non limiting example may be where a larger number of vehicles are allocated per resource, where the containers (or some of them) that need to be loaded onto the ship are scattered around the building at a relatively far distance one from the other, compared to a situation where a fewer number of vehicles may be allocated, e.g. when the containers are stored together relatively close to the quay where the ship docks. The invention is not bound by these examples and the number of vehicles allocated per resource may vary, depending upon the particular application.

In accordance with certain embodiments, in case the starvation time is not coped with, with respect to a given resource, e.g. due to peak demand of loading or unloading containers, the RSQ size may be dynamically increased, in order to assign a larger number of vehicles to the specified resource, or in case of low activity, decreased accordingly. It is this evident that the size of the RSQ may be (possibly dynamically) varied depending upon factors such as peak or low demand

Once a vehicle has completed a delivery task and its record is removed from the RSQ data structure (e.g. in step 617 of FIG. 6), a new vehicle may be assigned thereto (and its data record added to the RSQ data structure) to maintain the desired 7 pending vehicles, e.g. by re-executing the sequence of operations described with reference to FIG. 6.

As has been described with reference to FIG. 6 above (and will be further elaborated in the description below), the RSQ may be dynamically updated. Thus, as described in FIG. 6, after selection of a vehicle from among the candidate vehicles (step 611) that are designated to pass through a best path route (e.g. for reducing or eliminating the starvation time of a given resource at a given service cycle), the RSQ data structure for this particular resource is updated (step 612) namely the record representative of the selected vehicle will be updated in the RSQ data structure at the right location (namely a vehicle record for the selected vehicle will be stored in a position that corresponds to the service cycle for which this vehicle should provide the delivery service).

The update may be, for example, by replacing a record representative of a given vehicle (including the vehicle ID and its associated ETA) by the record representative of the selected vehicle, or updating fields in a record (in case that vehicle is already assigned to the resource but for instance its ETA should be updated). By the same token, upon finalizing the delivery service, the record of the specified vehicle is removed from the RSQ list (step 617).

Note that the invention is not bound by data structure for storing the RSQ (e.g. a table with records) and accordingly other data structure(s) in addition to or instead of the specified data structure may be utilized. Likewise, the invention is not bound by the data (illustrated by way of example in FIG. 7) stored with respect to each vehicle. Other data may also be stored in the RSQ, all depending upon the particular application. By way of another example, the invention is not bound by the utilization of a structure where the order of the vehicles (e.g. vehicle record) corresponds to the service cycle and accordingly other data structures and arrangements may be determined, all as required and appropriate.

Reverting again to FIG. 6, as may be recalled, the resources are prioritized based on resource starvation time (step 602). For a better understanding of this computational step attention is drawn to FIG. 8A illustrating a flow diagram of a general sequence of operations 800 for calculating resources' starvation time, in accordance with certain embodiments of the invention. The sequence of operations 800 is thus invoked by step 602 of FIG. 6. While the description below with reference to FIG. 8 refers to calculation of starvation time with respect to path routes, it may apply to hypothetical starvation time of hypothetical path routes where, in the latter, the Estimated Time of Arrival (ETA) of a candidate vehicle to a delivery bay should be read as hypothetical ETA of a candidate vehicle to a delivery bay.

Bearing this in mind, attention is drawn to step 802 of FIG. 8. Thus, at the onset (802), the number of vehicles that are assigned to the specified resource (having a given resource ID—e.g. crane number) are summed. This is performed by accessing the RSQ data structure (see 700 in FIG. 7, for this particular resource—identified by resource ID) that is stored in database (54). Initially this number may be e.g. arbitrarily set or determined, by running a simulation. For instance, a test is implemented for, say, i vehicles for a given storage arrangement. The simulation results are analyzed, for instance, to see if the quality of service is good, and whether starvation time ensues, and, if so, the number of vehicles may be increased e.g. to i+1 and so forth. This analysis may be applied to more complicated scenarios such as number of resources etc. The invention is not bound by these examples.

Thereafter, in step (803) a starvation time vector for this particular resource ID is initialized e.g. by assigning the value ∞ to each cell. The vector 850 is schematically illustrated in FIG. 8B. As shown, the vector includes n cells (of which the first two 851, 852 and the last 853 are marked), each representing a respective starvation time of the resource at a given service cycle.

The number of service cycles n may correspond to the number of vehicles that are required for the provision of delivery services to the specified resource. Thus, for example, if the number of required vehicles is 7, this means that there should be allocated 7 vehicles for servicing this particular crane during 7 consecutive service cycles. In each cycle #i, the crane is supposed to load or retrieve (which the case may be) an object (e.g. one or more containers depending, for instance, on the capacity of the crane and/or the vehicle) and load them to, or unload them from the vehicle that is supposed to park at the delivery bay of the multi-level structure and planned to provide delivery service during cycle #i.

If, in any of the specified 7 service cycles, the crane is “ready” to perform its unloading/unloading task to (or from) a vehicle, and the latter has not arrived as yet to the delivery bay, this leads to possibly an undue starvation time of the crane for this particular service cycle. The following steps in FIG. 8A will serve for calculating this starvation time.

In accordance with certain embodiments, the starvation time calculations are performed independently with respect to each service cycle, namely if a starvation time is calculated with respect to, say, the 5^{th} service cycle, this starvation time value is not carried forward and added for the calculation of starvation time with respect to the 6^{th} service cycle, but rather the calculation of the starvation for the latter cycle is performed independently and “from scratch”. The underlying assumption is that if a starvation time is found for the 5^{th} service cycle, it will be significantly reduced or eliminated (all as will be discussed and exemplified below) and therefore there is no need to carry it forward to the subsequent cycles. In accordance with certain other embodiments, other considerations may be applied, e.g. the calculated starvation time for a given cycle may be taken into account in consecutive service cycle(s). The latter illustrates an example wherein said calculating hypothetical starvation time for a given service cycle is carried on to the calculated hypothetical starvation time of at least one following service cycle.

Moving on to step 804 the number of required vehicles for this particular resource (as extracted e.g. in step 601) is subtracted from the number of vehicles assigned to the resource (as obtained from RSQ data structure 700) to obtain “absence” or “excessive” number of vehicles. Note that, initially, it is likely that the result indicates an “absence” of vehicles since no vehicles would have been assigned to the resource cycle as yet. This, as arises from step 810 below, will be reported and construed by step 602 of FIG. 6 as a starving resource (incorporated in the priority list) and will be processed as described in detail with reference to FIG. 6 above for e.g. reducing or eliminating the starvation of the resource. The latter reduction or elimination of starvation of the resource may be achieved e.g. by allocating an additional number of vehicles, until the desired number of vehicles per resource is met.

In accordance with certain embodiments, once the number of allocated vehicles meets the number of desired vehicles, then no starvation is encountered. However, certain events may disrupt this balance, e.g. a malfunctioning vehicle (whose record will be removed from the RSQ), leading to a “starvation” state for this resource (absence of one vehicle identified in step 804) which will lead to rectifying this situation by replacing the absent one with a new one.

In certain scenarios an excessive number of vehicles may be assigned to resources. For instance, if there is a pool of a hundred vehicles in the building and only one ship is docking at the quay and being served by one crane, then a larger number of vehicles than what is actually required may be allocated for the resource, or by way of another example a priori allocating an excessive number (more than average) of vehicles per the entire quay, in cases where peak demand is anticipated (e.g. it is anticipated more cranes than average would be operating along this quay, resulting in a higher container flow from the ships).

It is thus noted that the starvation criterion may depend on parameters other than starvation time, e.g. a starvation criterion may be encountered if the number of allocated vehicles is less than the number of desired vehicles per resource (per cycle). The specified parameters may be also combined, e.g. the starvation criterion may depend on starvation time and number of allocated vehicles vs. number of desired vehicles per resource (or resource service cycle).

It should be further noted that in certain embodiments the order of the vehicle records as listed in the RSQ data structure (each record representing a given vehicle) corresponds to the service cycle of the crane. Thus, for example, assume that the crane has provided, so far, service in 40 service cycles for loading/retrieving containers and to this end utilized 40 vehicles (some of which may have been used more than once). Then, for the subsequent 7 service cycles (41^{th} to 47^{th}) a corresponding 7 vehicles will be assigned with the first vehicle record (e.g. 702 in the RSQ data structure) representing a vehicle having the earliest ETA being assigned for the provisioning of the delivery service during the 41^{th} service cycle, the second vehicle (having the second earliest ETA) for the 42^{th} service cycle, and so forth. Note, however, that various circumstances may affect the Estimated Time of Arrival of vehicles, for instance, whereas the second vehicle in the RSQ list was supposed to have the second earliest ETA, its ETA has differed (and has been updated in the ETA field—as will be exemplified below with reference to FIGS. 9-10) and it is now later than the ETA of the 6^{th} vehicle.

Examples that may affect the ETA in the manner specified are: power loss, different container weights create different speeds for the vehicle, friction of the floor that was not anticipated (following rain, or lack of maintenance of a certain area in a building), a failure of another vehicle which got stuck on the way and caused congestion and slowed down the operation, a failure of one of the elevators, intervention from a remote user who decided to direct the vehicle to another location, etc.

Accordingly, in order to maintain vehicles' ETAs order in a way that corresponds to the service cycles' service time, it may be required to sort vehicles in the RSQ according to their actual ETA in order to verify the correspondence between vehicles' ETA and the appropriate service cycle, such that for the first (earliest) service cycle the vehicle with the earliest ETA will be allocated, for the second (second earliest) service cycle the vehicle with the second earliest ETA will be allocated, and so forth. After having sorted the ETAs accordingly, then at step 805 the vehicles may be ordered in ascending order starting from the earliest ETA (to the delivery bay). There may be certain scenarios wherein the process in 805 is performed based not only on the ETA order, but rather is affected by other parameters such as vehicle class—see further discussion below. Thus, and as will be exemplified below, the specified inquiry in 805 is applied to ETA ordered from earliest ETA per vehicle class, namely all vehicles of a given class are first processed, then vehicles of another class, and so forth. The ETA is extracted e.g. from the ETA field of the vehicle record in the RSQ data structure.

By this embodiment, the sorting step leads, thus, to correspondence between the vehicle# (in the sorted list) and the designated service cycle # of the crane.

Note that in accordance with certain embodiments and as will be explained in greater detail below, the sorting of the vehicles pertains only to vehicles having the same vehicle class, e.g. according to container parameters.

Then, in 806 the starvation time with respect to the vehicles is processed in a loop starting from the first in the list (the earliest arriving vehicle) and for each vehicle embraced by the loop an inquiry is made (807) whether there is an estimated starvation time (e.g. for the N^{TH} vehicle) between the ETA of this vehicle (as extracted from the ETA field of the vehicle record in the RSQ data structure—possibly normalized relative to the current time Now( )) and the resource service start time for this (say the n^{th}) service cycle (Service Cycle Time_{Resource}_{_}_{ID}*(n−1), where Service Cycle Time_{Resource}_{_}_{ID} signifies the service duration per cycle for the resource identified by Resource_ID.

Turning to the first vehicle in the sorted list, the inquiry (in 807) will determine whether the first vehicle arrives later than the required resource service start time of the crane (for the first service cycle thereof) and, if in the affirmative, the difference (representing starvation time for the first service cycle) will be recorded (808) in the first cell 851 of the starvation vector 850. In the next iteration, the inquiry (in 807) will determine whether the second vehicle in the (sorted) list arrives later than the required resource service start time of the crane for the second service cycle thereof and, if in the affirmative, the difference (representation starvation time for the second service cycle) will be recorded in the second cell 852 of the starvation vector 850, and so forth for all the 7 vehicles. Note that in accordance with certain embodiments the starvation time with respect to each service cycle is performed independently without considering the starvation times that were determined with respect to previous service cycles. In certain other embodiments, Starvation time, determined with respect to a given cycle, is carried forward and considered (wholly or partially) in the calculation of the starvation time for the subsequent cycle. Consider, for example, the following scenario: a calculated starvation time with respect to a given service cycle is not coped with, i.e. no vehicle is selected to ride along a (best) path route that meets the starvation criterion e.g. achieves reduction or elimination of the calculated starvation time because all the vehicles are busy and there is no single vehicle that can be allocated for this service cycle. This may lead to considering the so calculated starvation time in the calculation of the starvation time for the subsequent cycle.

Reverting now to step 807, for any vehicle #n (e.g. out of the 7 vehicles) the starvation time [n] is calculated by subtracting (i) the resource service start time of the n^{th} service cycle for this particular resource (obtained by multiplying the Service cycle time for this crane by the number of cycles (n−1)) from (ii) the ETA of the vehicle.

The starvation time results are then recorded in the starvation vector.

The output would be the starvation vector representative of the starvation times for each service cycle per resource, and the number of absence vehicles in the RSQ (see steps 809 and 810).

Obviously, other data may be obtained, such as total delays accumulated in the vector etc., all as required and appropriate.

As may be recalled, in accordance with certain embodiments, the starvation time of the resources and possibly the number of absent vehicles may serve for prioritizing the resources (in terms of allocating vehicles thereto). There may be other factors that affect prioritization of the resources in the priority list e.g. cranes having a lower number of vehicles assigned thereto than that which would be required (as discussed e.g. with reference to step 804). As also discussed above, there may be other factors that affect priority of the resources apart from resource type (in case there is more than one type) and/or the specified calculated starvation time and/or absent vehicles, for instance manual intervention by the operator, such as assigning higher priority to a lower priority resource type (e.g. truck) which waits for an overly long time duration for service.

Another non limiting example is a terminal at a time of peak activity, wherein another ship nearby should be leaving before the currently served ship, thus human intervention may set cranes' priority to be higher than the priority of the cranes of the currently served ship.

The sequence of operations described with reference to FIG. 8, is performed with respect to each resource, giving rise to at least a starvation vector and number of absent vehicles with respect to each resource. Note that the invention is not bound by only the specified outputs and accordingly the specified outputs may be modified, and/or others may be added all as required and appropriate.

As has been explained with reference to step 602 of FIG. 6, after having being called to the procedure for calculating the starvation vector and number of absent vehicles with respect to each resource (as described with reference to FIGS. 8A-B), the resources may be prioritized. In accordance with certain embodiments, prioritizing of the resources is performed in descending order of predicted resource starvation time with the highest priority being the worst predicted resource starvation, giving rise to a priority list of resources.

Consider for example three cranes each being assigned with 7 vehicles. Further assume that after executing the sequence of operations described with reference to FIG. 8, the following outputs are yielded:

A first crane associated with the following Starvation Vector [0, 0, 5, 0, 0, 0, 0], a second crane associated with the following Starvation Vector [0, 0, 0, 4, 2, 6, 3] and a third crane associated with the following Starvation Vector [0, 0, 3, 0, 0, 0, 0].

In accordance with certain embodiments, and where resource prioritization is utilized, the resource priority list will consist of the first crane in highest priority, then the third crane and lastly the second crane. This order was determined considering the fact that the first crane starves at the 3^{rd} service cycle with a longer starvation time duration (5) than that of the third crane (3) and at earlier service cycle (3^{rd}) compared to a later service cycle (4^{th}) of the second crane. Note that although the second crane is starving in four consecutive service cycles (from the 4^{th} to the 7^{th}) it is still ranked with lower priority relative to the other cranes starving at only one service cycle, however the latter cranes start to starve at an earlier starvation cycle (the 3^{rd}) compared to the 4^{th} of the second crane. The invention is not bound by the specified criterion (starvation at earlier service cycle) for determining the priorities in the priority list and accordingly other factors such as number of cycles in which a starvation is encountered may also affect the order in the priority list, as well as possible other factors.

By another example, crane 2 from the above example belongs to ship A, and cranes 1, 3 belong to ship B. Ship A is planned to depart in one hour. Ship B is planned to leave by the end of that day. So the service for ship A is more urgent.

By another example, intervention by a human operator is invoked. Thus, the remote operator for some reason has an immediate need for the container which is supposed to be downloaded at sequence [3] of the second crane—and thus it receives a higher priority over cranes 1 and 3.

The invention is not bound by these examples.

Reverting to FIG. 8, as may be recalled, the vehicle records were sorted according to their estimated ETA (step 805). Note that in accordance with certain embodiments, the specified sorting is subjected to vehicle class.

Consider, for example, a scenario of a vehicle loading containers to a crane which in turn loads them onto the ship. The container in the ship may be loaded in a given order, say first quota of containers that are designated to be unloaded in a first port (for example when the ship docks in Cyprus) and a second quota of containers that are designated to be unloaded in a second port (Italy). The containers designated to the first port should preferably be stacked at a given storage area of the ship whereas the containers designated to the second port should preferably be stacked at a different storage area of the ship (possibly even the second quota is piled over the first). Obviously, a situation where a container designated to the second port is stacked in the first area designated to the first port, should preferably be avoided (because this may lead to an undesired situation in that a container designated to Cyprus would be unloaded in Italy or vice versa). By this example, only vehicles that carry containers designated to Cyprus should, at first, be allocated to the crane and upon loading of all the containers that are designated to Cyprus, then vehicles carrying containers that are designated to Italy would be assigned to the crane (and therefrom, e.g. stored at a different location in the ship). Thus, in step 805, the vehicles of a given class (e.g. carrying containers that are designated to a first port, or designed to a first port and which are of the same weight, or designated to a first port and have the same weight and same dimensions) will be sorted, ignoring other vehicles, even if the latter has a preferable ETA, and only upon finalizing the processing of the specified vehicles and calculating the pertinent starvation times (as discussed in detail above), the procedure will be repeated this time with respect to the vehicles of the other class (e.g. carrying containers designated to the other port or carrying containers to the same port with different weight category). Note that the specified example of handling vehicles of different classes (depending for example upon container parameters, examples of which were discussed above, such as the destination of the containers and/or weight category and/or dimensions etc.) has been provided for illustrative purposes only, and, accordingly, container parameters e.g. containers designated to different locations, should not necessarily entail dividing the vehicles into distinct classes.

Another container parameter that may affect vehicle class (separately or in conjunction with others) is, for example, container weight. Thus, for instance, all the heavier containers should be stacked first and the lighter containers should be piled on top of the heavier ones. There may be other parameters (container parameters and/or others) that affect vehicle class, all as required and appropriate.

Reverting again to FIG. 6, after having constructed a resource priority list and determining a list of candidate vehicles (all as discussed above), there is a need to determine hypothetical path routes (with respect to each candidate vehicle—see step 609 in FIG. 6) and determine (from the hypothetical path routes) the best path route (see steps 610-612 in FIG. 6) that will meet the starvation criterion, e.g. achieve best reduced starvation time. In accordance with certain embodiments, this calculation has to be performed with respect to each service cycle of each resource.

In this context, attention is drawn to FIG. 9 illustrating a flow diagram of a general sequence of operations for calculating hypothetical path routes, in accordance with certain embodiments of the invention, and to FIG. 10 illustrating a flow diagram of a general sequence of operations for calculating a vehicle's best path route, in accordance with certain embodiments of the invention. Thus, in accordance with certain embodiments, the sequence of operations described with reference to FIGS. 9 and 10 may be invoked from step 610 of FIG. 6.

Turning to FIG. 9, in accordance with certain embodiments, candidate path routes are firstly determined (901). In accordance with certain embodiments a candidate path route may be the shortest path determined based upon known per se techniques such as Breadth first search (BFS) for finding a shortest path in a graph where the graph is constituted by the bays of, say, building 14 and the so determined path commences from a current bay (which accommodates, or will accommodate, the candidate vehicle), and ends at the delivery bay where the delivery service is provided. Note, incidentally, that determining the shortest path route may be used for determining a corresponding hypothetical path route and does not necessarily mean that this path would qualify as the best path that meets the starvation criterion e.g. achieves the best reduced starvation criterion (for a given service cycle) for the simple reason that there may be delays in passing one or more of the path bays of the path route. Thus, for example, if the shortest path includes only four bays but one of them is an elevator bay, the vehicle may be compelled to wait a relatively long time until the elevator becomes vacant and allows the vehicle to use it, and therefore the shortest path route would be inferior to a longer one (say, including 6 bays), but with less delays in each bay. The invention is not bound by the utilization of shortest path calculation.

Moving now to step 902, a best path is calculated as described in greater detail with reference to FIG. 10. The procedure starts with a loop on all possible candidate path routes 1002 (for instance that were determined in step 901), and executes the following steps with respect to each candidate path route.

Before moving on, in accordance with certain embodiments, there is provided a bay's state data structure (not shown in FIG. 10) operative to store with respect to each bay of said plurality of bays, a bay state indicative of a series of temporal occupancy states of the bay, and wherein determination of the hypothetical Estimated Time of Arrival (ETA) of each of said calculated hypothetical path routes, takes into account the bay state of each bay of the bays of the hypothetical path route. Each temporal occupancy state of said series may be indicative of a point in time and duration in which said bay becomes occupied or vacant, respectively.

Thus, by way of example, if a hypothetical path route includes a certain bay that the candidate vehicle may pass, then the bay state is tested for determining the hypothetical ETA for this particular bay. Assume that the hypothetical ETA of the vehicle for the current bay, is t₁. If, for example, the temporal occupancy state of bay, indicates that the bay is vacant, say, from a point in time t₀ for a duration of Δ₀, such that t₀<t₁ (meaning that bay, became vacant before the hypothetical ETA of the vehicle), and further assume that the vacancy duration Δ₀>>Δ₁ where the latter is the traversal time that is required for the candidate vehicle to pass bay₁ such that t₀+Δ₀ is later than t₁+Δ₁, this indicates that candidate vehicle may utilize, instantaneously, the bay, and the hypothetical ETA of the candidate vehicle may be updated to a new hypothetical ETA (t₁+Δ₁). The next temporal occupancy state (of the series of temporal occupancy states) of bayᵢ may indicate that the bay is vacant from point in time t₀+Δ₀ for a duration of say Δ₂ and so forth.

Moving on with this exemplary scenario, the candidate vehicle arrives at the next bay (bay_{I+1}) of the hypothetical path route at hypothetical ETA=t₁+Δ₁. Assume that a temporal occupancy state (of the series of temporal occupancy states) of bay_{I+1} indicates that bay_{I+1} will become available at t₂>t₁+Δ₁ namely it will become vacant at a point in time t₂ which is later than the ETA of the vehicle to bay_{I+1} and for a duration Δ₂. Put differently, by the time that the candidate vehicle is planned to hypothetically arrive at bay_{I+1} the latter is occupied. It may be occupied because, for instance, another vehicle is planned to use it during this time duration, or for instance it may store a container which blocks the bay and does not allow the candidate vehicle to pass it. The invention is not bound by the specified examples.

Moving on with this example, the hypothetical ETA of the vehicle for bay_{I+1} may be updated to t₂+Δ₁ (where t₂ is the point in time that the bay would become vacant as derived from the temporal occupancy state of the bay) and Δ₁ is the hypothetical traversal time of bay_{I+1}.

Note that whereas by this example the hypothetical traversal time of both bays was Δ₁ this is of course not necessarily always the case. For instance the traversal time (being an example of utilization time) of a regular bay may be shorter than that of an elevator bay etc.

The procedure moves on until the hypothetical ETA of the candidate vehicle at the delivery bay of the hypothetical path route is determined.

Note that the representation of temporal occupancy state of a bay does not necessarily indicate when the bay is vacant, but may, for example, indicate when the bay is occupied. Moreover the specified utilization of point in time and duration as temporal occupancy, is by no means binding.

Note that as long as the calculation pertains to hypothetical path routes, the temporal occupancy data with respect to the bays that constitute the hypothetical path route, are not updated. As will be evident from the description below, the temporal occupancy data of the bays that constitute a path route will be updated in the bay state data structure only once the hypothetical path route becomes a selected best path route (“committed”)—see step 612 of FIG. 6 and the description below with reference to FIG. 10.

Bearing this in mind, attention is drawn to FIG. 10.

Thus, in order to determine the Estimated time of Arrival (ETA) of a vehicle with respect to each hypothetical path route, the current bay that accommodates the candidate vehicle (that is associated with the currently processed hypothetical path route) is determined 1003 as well as the hypothetical ETA_{START} to this bay. Note that the current bay may be a bay at which that the candidate vehicle would hypothetically start its journey through the hypothetical path route possibly in the future e.g. when it terminates its current mission. The ETA_{START} would then designate the future point in time at which the candidate vehicle is planned to hypothetically arrive at the bay.

The current time tag t_{START} for this start bay is recorded and the ETA is set with this value (future start time will be recorded for path routes that will become active at a later stage, e.g. for future service cycles), then at 1004 all path bays of the thus hypothetical path route are processed as follows:

For each one of the path bays: determining, utilizing the bays state data structure, and, in particular, the relevant temporal occupancy state for the current bay (indicative e.g. of the point in time and duration that the relevant bay is occupied or vacant, whichever the case may be) the earliest time in which the path bay becomes vacant, record this earlier time tag 1005, and update the Estimated Time of Arrival (ETA) of the candidate vehicle accordingly 1006 (e.g., in database 54). Then, a similar calculation is performed with respect to the next bay of the path 1007 and so forth, until the delivery bay is processed in a similar fashion, giving rise to determination of the hypothetical Estimated Time of Arrival of the vehicle through the currently processed hypothetical path route (1008). The so determined hypothetical ETA is utilized to determine the resource's hypothetical reduced starvation time for the current processed hypothetical path route, all as discussed in detail with reference to FIGS. 6 and 8 above. Note that by this embodiment the starvation time is calculated with respect to a given service cycle of a given resource (e.g. crane). Note also that this is only a temporarily calculation and the achieved hypothetical reduced starvation time for this hypothetical path route is not as yet “committed” and subsequently logged in the RSQ vector (e.g. 700) and similarly the bay's state vector is not updated because a similar calculation is be performed with respect to all hypothetical path routes and only the one that will meet the starvation criterion, e.g. achieve the best reduced starvation time, will be selected and recorded in the RSQ data structure, and the corresponding temporal occupancy data for the bays that constitute the selected best path route will be updated in the bay state data structure (in step 612). Moving on, in step 1009 the best path route is determined (from among the hypothetical path routes) such that a starvation criterion is met, e.g. it achieves a best reduced starvation time associated with the resource (e.g. the specified crane) for a given service cycle, compared to a reduced starvation time associated with the resource that is achieved by any other hypothetical path routes. As may be recalled, the starvation time is calculated (with respect to a given service cycle of a given resource) as the time interval commencing from a resource service start time and terminating at the ETA of the vehicle arriving at the delivery bay (as calculated in step 1008), during which the resource (crane) is assumed to wait for the vehicle for provisioning of a delivery service. Note that the invention is not bound by the specified sequence of operations as outlined in FIG. 10. Thus, by way of example, instead of determining candidate path routes and determining the best path route from among the candidate path routes, as discussed above, the following modified sequence will apply. Thus, in accordance with certain embodiments, one or more hypothetical path routes are determined with respect to each candidate vehicle and, from among them, a best local candidate path route is determined (corresponding to a given candidate vehicle) where the latter path route meets a local starvation criterion e.g. achieves a local best reduced starvation time. The best path route is then determined from among said local best candidate routes.

In accordance with certain embodiments, the bays state data structure includes at least two types (for instance two data structure types), each depending on different vehicle properties. Examples of properties are, for instance, vehicles loaded with a container(s), or unloaded. Moving on with this example, in certain embodiments unloaded vehicles can pass through occupied bays (e.g. underneath support 32 in FIG. 3), whereas loaded vehicles cannot do so. This may expand the options of selecting even occupied bays for unloaded vehicles that form part of a candidate path route compared to loaded vehicles that cannot pass through such an occupied bay until the latter is vacated. Obviously, by this example, the “occupied” bays are indeed deemed occupied (until becoming vacant) for loaded vehicles but are considered “vacant” for unloaded vehicles (namely allowing the unloaded vehicle to readily utilize them). Loaded or unloaded vehicles are only example of vehicle types that may affect the decision whether a vehicle of a given type may or may not pass through an occupied bay. Reverting again to FIG. 6, as has been described above (see step 612 of FIG. 6), after having determined the best path route (as described with reference to FIG. 10) the associated vehicle is selected and the RSQ is updated with the vehicle data. For example, the record representative of the selected vehicle will be updated in the RSQ data structure at the right location (namely a vehicle record for the selected vehicle will be stored in a position that corresponds to the service cycle for which this vehicle should provide the delivery service). The update may be for example replacing a record representative of a given vehicle (including the vehicle ID and its associated ETA) by the record representative of the selected vehicle, or updating fields in a record in a case where the vehicle record stored in the RSQ data structure corresponds to the selected vehicle, but the ETA has been improved (leading to reduction or elimination of the starvation time) and accordingly updated. The selected vehicle may be classified as busy (for the time duration of the designated best path route) and the path and delivery bays of the best path route may be updated by an appropriate temporal occupancy state (in the bay state vector) e.g. by storing the point in time and duration in which the bays of the so determined best path route would become occupied when the selected vehicle would pass through them. The description with reference to FIG. 6 further describes the sequence of operations performed upon utilization (e.g. traversal) of the bays of the best path route by the selected vehicle. Before moving on, it should be noted that the series of computational steps in each of the sequences of operation in respective FIGS. 6, 8, 9 and 10 has been provided for illustrative purposes only and is by no means binding. Accordingly, in any of the specified sequences certain stage(s) may be modified or deleted and other(s) may be added and/or the order of some of the steps may be modified, all depending upon the particular application.

Before moving on with examples with reference to FIGS. 11A-F, it should be noted, and as has been discussed with reference to processor 50 (see FIG. 5 above), the operations (or part thereof) e.g. discussed with reference to FIGS. 6 to 10 may be performed at a processor residing outside the vehicle or performed mutatis mutandis at a processor residing in the vehicle or divided between the vehicle processor and outside of vehicle processor. The latter may be located remotely. locally or both depending upon the particular embodiment.

There follows a description of a certain embodiment where the operations are performed partially at the vehicle processor. By this example processor 51 stands for a processor residing at the vehicle and also a processor residing outside the vehicle.

Reverting to FIG. 6:

In step 601: the control may continuously send the status of the resources (e.g. cranes, workstations for AMAZON™ example) to the vehicles, then the vehicles may each calculate and decide (in processor 51) which CRANE it should move to—all as stipulated in step 601.

Steps 602 to 604 may be performed at the vehicle using calculations of processor 51.

In step 605: Each vehicle may determine if it is a candidate according to a vehicle candidacy criterion. Each vehicle may send a result to the remote control (e.g. Candidate/NO candidate).

In step 607: the vehicle may calculate rough ETA (each vehicle e.g. utilizing a building map for this to work e.g., stored in local database 54). In step 608: All (candidate) vehicles may send to the remote control their rough ETA and the remote control may return a request to continue to “609” only for relevant vehicles.

In step 609: Each relevant vehicle may perform step 610.

In step 610: Each vehicle may implement it utilizing the building map. Note that the vehicle receives (see step on 601) cranes/workstations RSQ so it may calculate the best route to meet the starvation criterion.

In step 611: Each vehicle may send its result to the remote control and the latter may select a vehicle associated with Best Path Route. Then control may send a decision to all vehicles so they know which has been selected. In certain embodiments the control may send the result to the vehicle associated with the Best path route. Step 612 may be performed both at the vehicle and the remote control end.

Both Steps 613 to 615: may be performed at the vehicle end on the vehicle. Steps 616 and 616 may be performed at the remote control.

Turning to FIG. 8:

In step 802: If the remote control sends continually to all vehicles, each of the RSQs, then this step may be performed at each vehicle

Steps 803 to 805 may be performed at the vehicle end (using e.g. a parameter “Busy” stored at the RSQ):

Steps 806 may be performed by the vehicle (per each vehicle) and the following Steps 807 and 808 may be performed in the vehicle.

With reference to step 809: the RSQ is now updated on the remote control by this vehicle's results (calculated at the vehicle end) such that the RSQ is updated when step 802 is invoked.

Turning now to FIG. 10, assuming that all vehicles also hold the dynamic database of the entire bays (e.g. in database 54) representing the building, and receive them from the remote control then the various operational steps described with reference to FIG. 10 may be also be performed at the vehicle end. Once the best path is determined, control is reverted to FIG. 6 path, and decision re the so determined best path route is transmitted to the selected vehicle associated therewith (611/612).

Note that the invention is not bound by the specified series of actions described above with reference to any of FIG. 6 8 or 10, performed between a vehicle processor (and pertinent modules such as database and communication) and outside vehicle processor (and pertinent modules such as database and communication) which is provided for illustrative purposes only. In accordance with certain embodiments, other implementations of actions partially performed by at least one vehicle processor (and pertinent modules such as database and communication) are applicable and/or outside of vehicle processor (and pertinent modules such as database and communication) may be performed.

It should be also noted that the invention is not bound by the specified data structures described with respect of various embodiment of the invention. Thus, in accordance with certain embodiments data structure that pertains to the vehicle may be utilized (and stored e.g. in database 54).

| | |
|---|---|
| Field 1 | Vehicle Data: |
| | Vehicle ID |
| | Time to be free (becoming |
| | Stand by) |
| | Status Indicators: Stand by |
| | status, Busy Status, Battery |
| | Status, health monitoring |
| | sensors status etc. |
| | Clock and Idle Time Counter |
| | Vehicle Class |
| Field 2 | Mission Data: |
| | Resource number to be served |
| | Service cycle to be served |
| | ETA to each delivery bay |
| | Type (download/upload) |
| | Path (bays of path route bays) |
| Field 3 | Container data: |
| | ID |
| | Weight (may effect drive |
| | speed) |
| | Size |
| | Container property |
| Field 4 | ETA's of THIS vehicle to all |
| | RSQs |
| | RSQ-1 |
| | RSQ-2 |
| | . . . |
| | RSQ-n |
| Field 5 | ALL RSQ's data: (e.g. as |
| | described with reference to FIG. 7) |
| | RSQ-1 |
| | RSQ-2 |
| | . . . |
| | RSQ-n |
| Field 6 | Building MAP (e.g. bays |
| | location in the building) For example, |
| | one building is 12*14, 12 floors |
| | height, another is 24*30, 10 floors |
| | high. The vehicle requires information |
| | about the geometry of the inside of |
| | the building - location of pillars, |
| | where each bay is, if a certain bay is |
| | “closed for maintenance” etc. |

In accordance with certain embodiments, there follows a description of a the various sequence of operations with respect to FIGS. 6, 8 and 10, utilizing the specified vehicle data structure.

FIG. 6:

Step 601: Update data in field 5; For every RSQ Field, update the RSQ data structure with updated data from the control about each Vehicle (ID, ETA, property) in the RSQ

Step 602: Update data in field 5—SORT the list of RSQs fields with accordance to FIG. 8. Instructions by the vehicle itself

Step 605: check field 1 and field 2 and send result to the control—Candidate or not candidate.

Step 607: Update data (e.g. Vehicle ETA for RSQ currently being checked) in field 4 using data from Field 6—update the ETA for the service cycle of the RSQ the vehicle is currently checking itself as a candidate. Note—Also field 4 may be a result of calculation and is optional.

Step 608: Send data from Field 4 to control

Step 610: Update data in Field 2 (e.g. ETA, Path) using Field 6

Step 612: Update Field 1 (e.g. Busy)

Step 613: Check Field 1

Step 614: Update data in Field 1

FIG. 8:

Step 802: Check Field 5

Step 803-804: Use Data about each Vehicle per each RSQ in Field 5 to perform the required calculations

Step 805: Sort Field 5

Step 807: calculation using vehicle's ETA data in Field 5.

FIG. 10: All may be done by checking Field 6 (for most updated map of the building),

Field 1 (for clock) and Field 2 (for setting the theoretical path and time until it is set if/when chosen).

The specified sequence of operations with reference to FIGS. 6, 8 and 10 was provided for illustrative purposes only and is by no means binding.

Bearing this in mind, the operation of a system in accordance with certain embodiments of the invention will now be described by way of example only with reference to FIGS. 11A-F. Note that the description below with reference to FIG. 11 is provided for illustrative purposes only and is by no means binding. Thus, as shown in FIG. 11A, prior to arrival of a ship which will dock in quay 1101 certain data is gathered. Note that other vehicles generally marked as 1102 are already engaged (they have, or are about to have, a busy state) in servicing another ship 1103 through cranes 1104 and 1105 that park in the vicinity of delivery bays of the multi-level structure (not shown). Other vehicles generally marked as 1106 are classified as standby and may be employed in servicing the upcoming ships. As discussed in 601 of FIG. 6, the data that is gathered and delivered to control system 50 (either received through communication module 55, or extracted from database 54) may include, for example: # containers to be unloaded from the ship# containers to be loaded onto the shipID of the containers within the building to be loaded onto the ship. Time of arrival of the ship (expected)—being updated as time laps until actual arrival of the ship. Expected Start Time for unloading/loading procedures. Expected location for docking along the quay—defining the relevant delivery bays—being updated as time laps until actual docking# cranes that will be assigned to the loading retrieval actions on the ship. Container details (destination, dimensions, weight, etc.) Other data may used by control system 50, such as: Required exit time from the terminal. Required # vehicles to be assigned to ship/cranes. Exact crane location (where to send the vehicles)—this may be determined after the actual docking. Also this may dynamically change—cranes move between ship rows. For instance, a crane that has completed a task of loading/retrieving containers from a ship may move to a different ship and the whole sequence of operations described above may be invoked in connection with serving the new ship. Init command moves standby vehicles to a location close to expected docking of the ship. Note that the latter may be performed either as a preliminary step 601 or for instance at a later stage (e.g. after prioritizing the cranes 602 and/or determining candidate vehicles 605). Init starvation vector per each of the cranes (e.g. in database 54) follows.

The description will, for simplicity, assume that one ship should be served at the quay 1101 and to this end two cranes A and B (1110 and 1111, see FIG. 11B) are utilized, each located nearby a corresponding delivery bay (not shown). Note incidentally, that the cranes are not necessarily associated to a fixed delivery bay and, if necessary, may move and provide (or be provided with) a delivery service at a different delivery bay. The starvation vectors for the specified cranes are initialized, e.g. Starvation_Vector_A: [∞∞∞ . . . ∞] Starvation_Vector_B: [∞∞∞ . . . ∞] Where

n₁: minimum # vehicles required for Crane A

n₂: minimum # vehicles required for Crane B

n₁, n₂ may be arbitrarily selected or for instance in accordance with certain criteria, e.g. in compliance with a preliminary simulation that was executed to assess the number of vehicles that should be allocated per crane. Another example is docking location—for example the vacant target storage bays for storing containers in the building being unloaded from the ship are distant from the crane, and thus more vehicles are needed to keep the cranes busy, giving rise to a larger number of required vehicles. The latter scenario may have been taken into consideration in the specified simulation.

S_{A}: Service_Cycle_time_Crane A

S_{B}: Service_Cycle_time_Crane B

The service cycle time may be identical or different, whichever the case may be.

Eventually, it would be desired to meet a starvation criterion, for instance reduce or eliminate the starvation time, giving rise to the following starvation vectors (after selecting vehicles from among candidate vehicles, assigning them to the various service cycles of the cranes and determining the best path routes which achieve best reduction or elimination of the starvation time)

Starvation_vector_A: [0, 0, 0, 0 . . . 0]

Starvation_vector_B: [0, 0, 0, 0 . . . 0]

The latter starvation vectors indicate a desired final stage.

The description below demonstrates how this desired result is attained. Note that the specified final stage (where starvation of the cranes has been eliminated) may be altered due to various circumstances (e.g. technical malfunction—or various other reasons).

As has been discussed above, the specified initiation step may apply to all cranes rendering them all “starving”. Then, applying the specified sequence of operations in accordance with various embodiments of the invention may lead to elimination of the starvation and “smooth operation” of the robotic harbor where all the resources (e.g. cranes) are efficiently utilized without or with very little delay.

However, if a “failure” event is encountered, such as a malfunctioning vehicle or a vehicle moving slower than expected (e.g. due to non-uniform friction among the vehicles), malfunctioning elevator bay etc., this may lead to generation of a starvation state for a given crane with respect to one or more service cycles due to discrepancy between the planned ETA of the vehicle to a bay (a delivery bay and possibly interim bay(s)) according to the best path route and the actual ETA of the vehicle to the specified bay(s). This will call for re execution of the specified method according to various embodiments of the invention, giving rise to reduction or elimination of the newly generated starvation event.

Bearing this in mind and reverting to the example, the sequence of operations for assigning the vehicles to cranes A and B with respect to a specific service cycle will be exemplified with reference to FIGS. 11C and 11D.

Focusing for a moment on RSQ data structure of crane A, and assuming that crane A becomes operable at time T_{NOW} (resource service start time is T_{NOW}) and further assume n=7 (representative of a Quality of Service that guarantees availability of 7 vehicles for 7 consecutive service cycles) then ultimately the RSQ lists the following records:

ETA List

vehicle-1

ETA: T_{now}

State: empty

vehicle-2

ETA: T_{now}+S_{A}

State: empty

vehicle-7

ETA: T_{now}+6*S_{A}

State: empty

Where “State” is an example of a vehicle's property and is indicative of whether the vehicle is “empty” (ready to be loaded with a container from the crane). As can be readily noted, the ETA for the 7^{TH} vehicle should be: T_{now} (the crane A's service start time for the first service cycle)+6 times S_{A}, where S_{A} is the time duration required for crane A to provide delivery service in one service cycle and 6 indicates the 6 cycles allocated to the previous six vehicles.

Assume, for sake of discussion, that, during run time, delays may occur, and therefore the record for the 7^{TH} vehicle in RSQ data structure indicated a starvation of two service cycles (i.e. 8*S_{A} instead of 8*S_{A}), namely:

vehicle-7

ETA: T_{now}+8*S_{A}

State: empty

Consequently, the starvation vector for both cranes will be as follows

Crane_A_Starvation_Vector [0, 0, 0, 0, 0, 0, 2*S_{A}]

example: Crane_B_Starvation_Vector: [0, 0]

where, as shown, in the 7^{TH} location of the starvation vector the starvation time of 2*S_{A} is indicated.

Applying the prioritization sequence of operations (e.g. step 602 and FIG. 8A) will result in Crane A having higher priority over Crane B for associating vehicles thereto. Note that in accordance with certain embodiments, there is no need to apply steps 603 and onwards with reference to Crane B, as no starvation has been encountered with respect to any service cycle thereof.

Focusing thus on Crane A and assume that after applying the vehicle candidacy criterion on the basis of the shorter hypothetical path route criterion (see 605) the vehicles embraced by rectangular 1112 are classified as candidate vehicles where 3 vehicles in cluster 1113 are candidate to Crane A and those in cluster 1116 to Crane B. The other vehicles (in group 1115) are assigned to a different ship.

Further focusing on Crane A, a more complex candidacy criterion may define vehicles (1) 1120, (2) 1121 and (3) 1122 as candidate vehicles, for instance,

vehicle (1) is about to complete mission for Crane A

vehicle (2) is in standby state; and

vehicle (3) is an excessive vehicle in the RSQ data structure for Crane B.

Note that the latter are only examples of vehicle candidacy criteria.

Assuming that applying the best path route analysis described, for instance, with reference to FIGS. 9-10 will result in the following:
(1) The hypothetical best (local) path route for vehicle 1120 (which is also the shortest compared to the other two paths (2) and (3)) will lead it to arrive immediately, namely ETA₍₁₎=T_{now}+0*S_{A}=T_{now}
(2) The hypothetical best (local) path route for vehicle 1121 will lead it to arrive at an ETA=T_{now}+5*S_{A}
(3) The hypothetical best (local) path route for vehicle 1122 will lead it to arrive at an ETA=T_{now}+7*S_{A}

Since, as may be recalled, the vehicle is required at Time=T_{now}+6*S_{A}, this leads to two best (local) path routes (1) and (2), both eliminating the prevailing starvation time (2*S_{A}) for the 7^{TH} service cycles.

From among the two best path routes, path route 2 is selected according to the following exemplary vehicle best route criterion: the ETA of the vehicle 1121 travelling along path route (2) is later than the ETA of the vehicle 1120 travelling along path route (1), or, in other words, vehicle 1121 will wait less time than vehicle 1120 until Crane A becomes available.

Note that in the latter example, at first, best local candidate routes with respect to each candidate vehicle (1120, 1121 and 1122) are determined, and, from among the specified hypothetical best local path routes, a best path route, achieving said best resource's reduced starvation time, is selected.

The invention is not bound by the specified examples.

Note also that the specified selection between two best path routes (which in turn were selected from hypothetical path route candidates) is described for convenience of explanation, and accordingly, in accordance with certain embodiments the specified analysis, may be performed at the “hypothetical path routes analysis stages”, skipping the intermediate determination of best local candidate route, leading to a final selected best path route.

Moving on to FIG. 11E, there follows a sequence of operations for illustrating how the best (local) path route (2) (ETA=T_{now}+5*S_{A}) was selected from among possible hypothetical path routes of vehicle 1121. FIG. 11E illustrates a plan view of the multilevel structure 1123 with 7 by 10 bays for each floor, where vehicle 1121 is parked at bay 1124 (at coordinates 3,6) of, say the 6^{th} floor (marked also as 3,6,6) and needs to use an elevator (located in coordinates (5,3), (5,6) and (5,9) respectively) in order to arrive at the delivery bay associated with Crane A 1111.

For simplicity's sake, only four possible paths are drawn—path 2₁, 2₂, 2₃ and 2₄ e.g. selected by utilizing the sequence of operations of FIG. 9 (skipping by this example step 901).

Path 2₁ has the shortest path distance as it required the vehicle to travel along two bays in the 6^{th} floor (from coordinates (3,6,6) to the elevator at (5,6,6) and then five more path bays (from coordinates (5,6,5) to (1,7,5)) in the fifth floor) until it arrives at the delivery bay.

However, as will be illustrated below, the shortest path will not prevail over the other three alternative candidate path routes.

Hypothetical ETA is calculated per each of the paths and updates bay vacancy time accordingly.

Starting with Path 2₁ (by following e.g. computational steps 1004-1007 of FIG. 10), and assuming, for simplicity, that no delay is encountered in the next bay [4,6,6] (utilizing the bay state vector), then the following bay in the path, i.e. the elevator bay at [5,6,6] in the 6^{TH} floor is processed. Assuming that the vehicle arrives at ETA t1 at the elevator bay [5,6,6] and that the temporal occupancy bay state in the bay state data structure indicates an occupancy duration=[1,180] for this elevator bay. In other words, the elevator is occupied (“1”) for a relatively long time duration of 180 sec (e.g. is occupied due to serving another vehicle). The hypothetical ETA is updated by adding 180 sec to the current ETA, and the following bay, being the path 2₁ [5,7,5] to [1,7,5], as well as the delivery bay, (all being vacant) are processed in a similar fashion adding only short time duration to the ETA of path 2₁ (assuming that the temporal occupancy state for the bays indicates that they are all vacant and the traversal time through each bay is about 3 seconds (e.g. vehicle speed is 1 m/s (loaded) or 3 m/s (unloaded). Note that the latter 3 seconds traversal time per bay is provided for illustrative purposes only and the same holds true for the vehicle velocity.

Moving on to path 2₃, the vehicle that travels through path 2₃ has the longest distance commencing from bay [3,6,6], traveling to bay [3,10,6] and then to [5, 10, 6] then through the elevator bay at [5,9,6] to the fifth floor and therefrom through bay [5,7,5] to [1,7,5] and to the delivery bay. Path 2₄ includes exactly the same number of path bays as path 2₃.

Assuming that all bays are vacant, the ETA is updated for each bay by adding a travel time of 3 seconds (as indicated by the bay's state duration).

Path 2₂ in its turn is slightly shorter than 2₃ however in bay [4,9,6] the bay state data structure indicates that the vehicle has to wait 50 sec (e.g. a different vehicle loads a container in the specified bay).

It is accordingly appreciated that the hypothetically best (local) path route for vehicle (1121) in terms of ETA are the longest paths 2₃ and 2₄, however in accordance with certain embodiments, the best local path route is selected to be path 2₄ because the latter has an advantageous best path route characteristic which by this example is less 90 degrees curves (two for path 2₄ compared to three for path 2₃). The number of curves is of course an example of an advantageous best path route characteristic, and while applied by this example to select between two or more similarly best local path routes, in accordance with certain embodiments, can be applied at a later stage.

The so selected best path route 2₄ for vehicle 1121 has an ETA that that equals to specified T_{NOW}+5*S_{A} as discussed above.

By the latter example 13 bays were passed through+elevator_utilization_time_through one one floor (sixth=>fifth) giving rise to 13*3_seconds+10_seconds=total 49 seconds for traveling through the best path route.

As previously noted 5*Sa=5*2 minutes=10 minutes=600 seconds

Note that the discrepancy between the specified duration stems from the very simple example that was provided for clarity, only 13 bays (a very small storage arrangement), traveling through only one floor, etc.

In the latter example, the selected vehicle may either wait in idle time until the crane becomes available, i.e. more than 9 minutes, assuming that it is not allocated for a different task. Complying with “Just in time”, vehicle 1121 which was chosen, is arriving “more” just in time than vehicle 1120 who would have to wait more time.

As further discussed above and in accordance with certain embodiments, a hypothetical best local path route is selected for the other two candidate vehicles and from among the hypothetical best local path routes, the prevailing one (path 2₄) is selected and determined to be the best path route. The data record for the selected vehicle is updated at the right location in the RSQ data structure as well as the temporal occupancy state in the bay state data structure (see also discussion with reference to step 612 above) indicative of the point in time and the durations that the bays would be occupied when the selected vehicle 1121 would pass through them while traveling through the best path route.

Once the vehicle 1121 has finalized the provisioning of the selected service, it is classified as standby (assuming that it has loaded a container to the crane).

The same sequences of operations apply mutatis mutandis to a vehicle that is loaded with a container and has to carry it to a storage area in, or in the vicinity of, the multi level structure, or, in accordance with certain embodiments, onto a truck.

Trucks may be regarded in accordance with certain embodiments as another type of resource (possibly having a lower ranked category type than cranes—see e.g. step 602) and are managed in a similar fashion as described above with reference to cranes mutatis mutandis.

In accordance with certain embodiments if a vehicle loaded with a container tries to pass another bay with a container in it, the vehicle will be compelled to wait DELTA T>0 compared to a situation that an unloaded (empty) vehicle attempts to pass the specified bay and can pass through the bay without a delay. This may be implemented for example by utilizing a bay state data structure having at least two types each depending on different vehicle properties. Such a property may be for example a loaded or unloaded vehicle. Note that the specified data structure may be implemented as in the specified data structure, or, in certain embodiments, in a distinct structure.

Attention is drawn to FIG. 11F illustrating schematically a scenario of an empty truck 1151 that is approaching the multi-level structure 1151 to pick a container say 1152 stored in a given bay, and leave the area loaded with the specified container. By the latter example the empty truck can travel through the building underneath the first level. In accordance with certain embodiments, the truck enters the entrance e.g. 1151, the vehicle will bring the container to the bottom floor, the container will be loaded onto the truck (where the specified arrival of the truck, travel of the vehicle and loading the container is controlled in accordance with the various embodiments described above), and the truck will leave in reverse mode (through 1151). The invention is of course not bound by the specified interaction between the container and the truck and the latter may vary depending upon the particular application.

Reverting to FIG. 11F, a vehicle 1153 is selected from among a plurality of candidate vehicles (not shown) for moving through a best route path, first picking the container 1152 and then arriving at a delivery bay for unloading the container. The control 50 will pick a vehicle in accordance with the sequence of operations described above mutatis mutandis.

In accordance with an aspect of the invention there is provided a computerized vehicle navigation method that includes provisioning of a plurality of vehicles having only static sensing capacities operable to sense static surroundings associated with a plurality of bays and being devoid of dynamic sensing capacities of dynamic vehicles that are operable to utilize the plurality of bays.

Static sensing capacities operable to sense static surroundings associated with a plurality of bays may include at least one of the following sensors fitted e.g. on and/or or within a vehicle described by way of example with reference to FIG. 2. (i) An RFID tag (receiver) capable of receiving signals from RFID (transmitter) e.g. fitted on predetermined location of a storage arrangement (e.g. a building such as the one described with reference to FIG. 1C), (ii) an image acquisition sensor (e.g. a camera) capable of sensing traversal of bays e.g. according to predefined marking(s) depicted or disposed at predefined location(s) of a bay, e.g. a known marking such as X sign depicted in the middle of each bay's floor. In the latter example the camera may be fitted at the bottom of the vehicle and configured to acquire images of the floor, (iii) distance metering sensor based on revolution of the vehicle wheels based on predetermined known diameter of the wheel, possibly with an angle meter sensor for measuring the rotation angle of the vehicle. Assuming for example that the dimensions of each bay are known, then by utilizing the specified distance meter sensor and the angle meter sensor a processor (e.g. associated with the vehicle as discussed with reference to various embodiments above) may determine which bay the vehicle is utilizing and when the vehicle is moving to a neighboring bay. The same holds true for utilizing the specified image acquisition means where the processor can figure out e.g. by identifying the markings that a bay is being utilized and when identifying another marking that another bay is encountered, utilizing known per se image processing software. RF ID can identify e.g. when utilizing a bay by sensing an RF ID transmitted signal where the RF transmitter is fitted e.g. at a predefined location of the building. The invention is not bound by these specific examples of static sensing capacities operable to sense static surroundings associated with a plurality of bays.

As has been further specified, the vehicle is devoid of dynamic sensing capacities of dynamic vehicles that are operable to utilize the plurality of bays, for instance image acquisition means fitted on the vehicle configured to sense an moving object such as a vehicle traversing its route (whether the latter is moving or stationary) but without the sensing vehicle having predefined “knowledge” of the specified traversing vehicle utilizing the bay that the sensing vehicle wishes to utilize. Note that there may be a coincidence between the static sensing capacities and dynamic sensing capacities, e.g. both being a camera, however the former having associated therewith a software and/or hardware conferring the specified dynamic sensing capacities compared to (in many cases) a more degenerated software/hardware conferring the specified static sensing capacities.

Note that in certain embodiments static sensing capacities operable to sense static surroundings associated with a plurality of bays may be considerably cheaper than the dynamic sensing capacities of dynamic vehicles that are operable to utilize the plurality of bays, thereby reducing the overall price tag associated with a vehicle which, in certain implementations, may constitute a significant competitive factor.

Bearing this in mind, there is further provided dynamically determining with respect to each bay of a plurality of bays a bay state indicative of a series of temporal occupancy states of the bay, each of said temporal occupancy states is composed of at least (i) vacant state and duration during which a vehicle of said vehicles may utilize said bay or (ii) occupied state and duration during which a vehicle of said vehicles utilize or will utilize said bay; and determining at least one path route for at least one of said vehicles, wherein each path route of said path routes includes a start bay, at least one path bays and an arrival bay, of said plurality of bays; said determining with respect to each path bay including selecting said path bay out of possible bays of said plurality of bays utilizing the temporal occupancy states of the bay states of said possible bays and according to a path route criterion.

The latter has been described by way of example only with reference to the various embodiments while referring to at least the system of FIG. 5 and FIG. 10 where arrival bay is, by way of example, the specified delivery bay.

Note that in certain embodiments said criterion stipulates that the vehicle Estimated Time of Arrival to said arrival bay is earlier than any other hypothesized path bays that start from said start bay and end at said arrival bay. This however is not binding. In accordance with certain embodiments the specified criterion may include meeting the starvation criterion all as discussed above, e.g. with reference to FIGS. 6 and 8.

Based on the foregoing, a vehicle of said vehicles associated with the determined path route is operable to utilize the bays of said determined path route based on only said static sensing capabilities.

Consider, the example of FIG. 11E which is provided for illustrative purposes only. Vehicle 2 may move along selected path 2₄ while utilizing only the static sensing capacities for identifying the path bays cells that it needs to utilize, whilst being devoid of the dynamic sensing capacities because it will not encounter any unexpected moving or stationary vehicle in any of the path bays. This is guaranteed because any of the bays of the path route has been determined to be vacant when the selected vehicle utilizes the respective bay. This has been achieved by using the series of temporal occupancy states of the bays, all as discussed in detail above.

Unless specifically stated otherwise, as apparent from the following discussions, it is appreciated that throughout the specification discussions utilizing terms such as “providing”, “selecting”, “determining”, “calculating”, “reducing”, “prioritizing”, “classifying”, “provisioning”, “updating” or the like, include actions and/or processes of a processor that manipulate and/or transform data into other data, said data represented as physical quantities, e.g. such as electronic quantities, and/or said data representing the physical objects. The terms “processor”, and “controller” should be expansively construed to cover any kind of electronic device or devices with data processing capabilities.

The operations in accordance with the teachings herein may be performed by a processor specially constructed for the desired purposes or by a general purpose processor specially configured for the desired purpose by a computer program stored in a non-transitory computer readable storage medium (memory). The term “non-transitory” is used herein to exclude transitory, propagating signals, but to otherwise include any volatile or non-volatile computer memory technology suitable to the application.

As used herein the term memory or storage refers to any readable medium for storing data for the short and/or long term, locally and/or remotely. Examples of memory include inter-alia: any type of disk including floppy disk, hard disk, optical disk, CD-ROMs, magnetic-optical disk, magnetic tape, flash memory, random access memory (RAMs), dynamic random access memory (DRAM), static random access memory (SRAM), read-only memory (ROMs), programmable read only memory PROM, electrically programmable read-only memory (EPROMs), electrically erasable and programmable read only memory (EEPROMs), magnetic card, optical card, any other type of media suitable for storing electronic instructions and capable of being coupled to a system bus, a combination of any of the above, etc.

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination or included in separate embodiments.

In embodiments of the presently disclosed invention one or more stages (steps) illustrated in any of FIGS. 6, 8 and 10 may be executed in a different order and/or one or more groups of stages may be executed simultaneously and and/or some of the steps may be modified or deleted and/or others may be added. The figures illustrate a general schematic of the system architecture (e.g. FIG. 5) in accordance with an embodiment of the presently disclosed invention. Each module in the figures can be made up of any combination of software, hardware and/or firmware that performs the functions as defined and explained herein. The modules in the figures may be centralized in one location or dispersed over more than one location.

In embodiments of the presently disclosed subject matter, fewer, more and/or different stages than those shown in any of FIGS. 6, 8 and 10 may be executed. In embodiments of the presently disclosed subject matter one or more stages illustrated in any of FIGS. 6, 8 and 10 may be executed in a different order and/or one or more groups of stages may be executed simultaneously. FIG. 5 illustrates a general schematic of the system architecture in accordance with an embodiment of the presently disclosed invention. Each module in FIG. 5 can be made up of any combination of software, hardware and/or firmware that performs the functions as defined and explained herein. The modules in FIG. 5 may be centralized in one location (e.g. remote location) or dispersed over more than one location (e.g. also in the vehicle). In other embodiments of the presently disclosed invention, the system may comprise fewer, more, and/or different modules than those shown in FIG. 5.

Any trademark occurring in the text or drawings is the property of its owner and occurs herein merely to explain or illustrate one example of how the presently discussed subject matter may be implemented.

The system of FIG. 5 comprises or is otherwise associated with one or more processors configured to execute operations as disclosed herein. The term processor as used herein should be expansively construed to cover any kind of electronic device or devices with data processing capabilities, including, by way of non-limiting example, a personal computer, a server, a computing system, a communication device, a processor (e.g. digital signal processor (DSP), a microcontroller, a field programmable gate array (FPGA), an application specific integrated circuit (ASIC), etc.), any other electronic computing device, and or any combination thereof. Note that all examples may be composed of a single device or two or more devices at the vicinity of each other and/or located remotely one with respect of the other possibly operating independently or jointly.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed processor. Likewise, the presently disclosed subject matter contemplates a computer program being readable by a computer for executing the disclosed method. The presently disclosed subject matter further contemplates a machine-readable non-transitory memory tangibly embodying a program of instructions executable by the machine (processor) for executing the disclosed method.

1. A computerized delivery service provision method, comprising
(ii) providing a plurality of vehicles and a plurality of bays;
(iii) selecting vehicles of said plurality of vehicles for assignment to resources; said selecting of each vehicle with respect to a resource includes:
1. determining, for said resource, candidate vehicles of said plurality of vehicles that meet a vehicle candidacy criterion;
2. calculating at least one hypothetical path route associated with at least one of said candidate vehicles; each hypothetical path route including path bays, of the plurality of bays, through which said candidate vehicle would hypothetically pass and terminating at a corresponding hypothetical Estimate Time of Arrival (ETA) in a delivery bay of said bays, constituting an ETA of the hypothetical path route, for hypothetically provisioning of a delivery service between the candidate vehicle and the resource, giving rise to hypothetical path routes for said candidate vehicles;
3. calculating hypothetical starvation times associated with said hypothetical path routes, each hypothetical starvation time, of said starvation times, defining a time interval, commencing from a resource service start time of said resource and terminating at the hypothetical ETA of the hypothetical path route, of said hypothetical path routes, and during which the resource is assumed to hypothetically wait for the candidate vehicle that is associated with the hypothetical path route, for hypothetical provisioning of a delivery service;
4. determining a hypothetical path route from among said hypothetical path routes whose associated starvation time meets a starvation criterion and rendering the determined hypothetical path route as a best path route and selecting a vehicle from the at least one candidate vehicle associated with the best path route, for provisioning of the delivery service between the selected vehicle and the resource.

2. The method according to claim 1, wherein said starvation criterion is selected from a list that includes: reducing the starvation time to a minimum, eliminating the starvation time, and starvation time falling within a predetermined starvation time interval, whether positive or negative.

3. The method according to claim 1 or 2, wherein said starvation criterion with respect to a resource further depends upon other parameters including number of allocated vehicles vs. number of desired vehicles.

4. The method according to any one of the preceding claims, wherein further providing the following stages for execution between said (i) and (ii) further comprises:
A. calculating a starvation time with respect to each of a plurality of resources; each said starvation time defining a predicted time interval, commencing from a resource service start time and terminating at an estimated time of arrival (ETA) of a vehicle during which the resource is assumed to wait for a vehicle of said vehicles for provisioning of a delivery service;
B: prioritizing the resources according to a descending order of the resource starvation times with the highest priority being the worst predicted resource starvation time, giving rise to a priority list of resources; and wherein said (ii) further includes selecting vehicles of said plurality of vehicles for assignment to said resources according to at least said priority list.

5. The method according to any one of the preceding claims, wherein each bay of said plurality of bays is associated with a bay state indicative of a series of temporal occupancy states of the bay and wherein the hypothetical Estimate time of Arrival (ETA) of each calculated hypothetical path route is dependent upon the bay state of each of the bays of the route.

6. The method according to claim 5 wherein each of said temporal occupancy states is composed of at least (i) vacant state and duration or (ii) occupied state and duration.

7. The method of any one of the preceding claims, wherein in case that in said stage (ii) (4) more than one best path route is determined, all meeting said starvation criterion, the method further comprises:
selecting a vehicle from among the vehicles associated with said more than one best route, according to a vehicle best route decision criterion.

8. The method according to claim 7, wherein said vehicle best route decision criterion includes at least one of the following:
(i) the selected vehicle has lower accumulated battery power compared to a non selected vehicle;
(ii) the selected vehicle is associated with a shorter best path route of said best routes that includes first number of path bays and a delivery bay, compared to a longer best path route of the path routes that includes a second number of path bays, larger than the first number and a delivery bay, and
(iii) the selected vehicle meets a “Just in Time” criterion.

9. The method according to any one of the preceding claims, wherein said best path route is maintained even if it does no longer meet, on the fly, the starvation criterion.

10. The method according to any one of the preceding claims, further comprising classifying said selected vehicle as a busy vehicle in response to said selected vehicle commencing to pass through a first path bay of said best pass route;
classifying said selected vehicle as a standby vehicle in response to provisioning of the delivery service between the resource and said assigned vehicle.

11. The computerized delivery service provision method of any one of the preceding claims, further, comprising:
selecting vehicles of said plurality of vehicles for assignment to resources, and for each resource per each of at least two resource service cycles;
said determining of (ii)(1), calculating of (ii)(2), calculating of (ii)(3) and determining of (ii)(4) are performed in respect of each cycle of said service cycles.

12. The computerized delivery service provision method of claim 11, wherein said calculating hypothetical starvation times is performed independently with respect to each service cycle.

13. The computerized delivery service provision method of claim 11, wherein said calculating hypothetical starvation time for a given service cycle is carried on to the calculated hypothetical starvation time of at least one following service cycle.

14. The method according to any one of claims 4 to 13, wherein said resources are categorized into at least two types, and wherein said priority list prioritizes the resources according to said descending order in a higher priority for resources of a first type and in a lower priority for resources of a second type of said at least two types.

15. The method according to claim 14 wherein said at least two types include crane and truck types, and wherein said first type being said crane type.

16. The method according to any one of claims 4 to 15, wherein a first resource of said resources which has no vehicle, for which it is assumed to wait, has a higher priority in said priority list over a second resource for which there is a vehicle for which the second resource is assumed to wait.

17. The method according to any one of the preceding claims, wherein said vehicle candidacy criterion is met if at least one of the following conditions is met:
the vehicle is classified as a standby vehicle state;
the vehicle is assigned to a resource already having sufficient vehicles assigned thereto;
the vehicle is assigned to a resource and will be classified as a standby vehicle state before other vehicles are classified as being in standby vehicle state; the vehicle is of a given vehicle class; and
a vehicle has advantageous vehicle candidacy-related characteristics.

18. The method according to claim 17, wherein said advantageous vehicle candidacy-related characteristics include at least one of the following:
i. the candidate vehicle has lower accumulated battery power compared to a non candidate vehicle;
ii. the candidate vehicle is associated with a shorter hypothetical path route that includes first number of path bays and a delivery bay compared to a longer hypothetical path route associated with a candidate or non-candidate vehicle, wherein the longer hypothetical path route includes a second number, larger than said first number, of path bays and a delivery bay;
iii. two candidate vehicles of said candidate vehicles have identical hypothetical path route length but have better supplemental advantage selected from the group that includes a first vehicle which has less turns, or less usage of elevator bays compared to the second vehicle, or better ETA than the second vehicle;
iv. the candidate vehicle is a first vehicle in a resource Service Queue data structure.

19. The method according to any one of the preceding claims, wherein said calculating of said stage (ii) (4) includes:
determining with respect to each one of the candidate vehicles a corresponding best local candidate route, of the path routes associated with the candidate vehicle, that meets a local starvation criterion, giving rise to said best local candidate routes associated with said candidate vehicles;
and wherein said determining of said stage (ii) (4), further includes selecting said best path route that meets said starvation criterion from among said local best candidate routes.

20. The method according to any one of the preceding claims, wherein said at least one of said candidate vehicles has the same vehicle class.

21. The method according to any one of the preceding claim 1, further comprising:
providing, with respect to each bay of said bays, a bay state indicative of a series of temporal occupancy states of the bay;
and wherein said calculation of each of said hypothetical path routes, associated with a candidate vehicle, of said stage (ii) (2) includes:
taking into account the bay state of each of the bays of the hypothetical route;
and wherein said determining a best path route of said stage (ii)(4) further includes updating the temporal occupancy state of each bay of said best path route with a bay state reflecting the time duration that the selected vehicle will pass through the bay.

22. The method according to claim 21, wherein said bay state is representative of the point in time and duration in which the bay becomes vacant.

23. The method according to claim 21 or 22, wherein said bay state is representative of the point in time and duration in which the bay becomes occupied.

24. The method according to any one of claims 21 to 23, wherein said bays state data structure includes:
at least two types each depending on different vehicle properties;
wherein the calculation of each of said hypothetical path routes, associated with the candidate vehicle, is dependent upon the bay state from a bay state data structure type, depending upon the candidate vehicle property;
and wherein said determining of best path route further includes updating the temporal occupancy state of each bay of said best path route in a bay state data structure type that depends upon the properties of said selected vehicle, with a bay state reflecting the time duration that the selected vehicle will pass through the bay.

25. The method according to claim 24, wherein said vehicle properties include (i) vehicle loaded with an object or (ii) vehicle unloaded and (iii) vehicle height.

26. The method according to any one of the preceding claims, further comprising:
providing a bay state data structure operative to store with respect to each bay of said plurality of bays a bay state indicative of a series of temporal occupancy states of the bay;
and wherein said calculation of each of said hypothetical path routes, associated with a candidate vehicle, of said stage (ii) (2) includes: determining (i) a current bay of said bays which accommodates the candidate vehicle and (ii) a current or future time tag of said bay;
determining at least one path bay, of said plurality of bays, that follows said current bay and a delivery bay of said plurality of bays that follows the last of said succession of path bays; for each one of said bays, determining, utilizing said bays state data structure, the hypothetical estimated time of arrival (ETA) of the vehicle to said bay is indicative of when the vehicle may utilize the bay, giving rise to said ETA of the hypothetical path route;
and wherein the determining of said best path route, associated with the selected vehicle, of said stage (ii) (4) further includes:
updating the temporal occupancy state of each bay of said best path route with a bay state reflecting the time duration that the selected vehicle will pass through the bay.

27. The method according to claim 26, wherein said bays state data structure includes at least two types, each depending on different vehicle properties wherein
the calculation of each of said hypothetical path routes, associated with the candidate vehicle, is dependent upon the bay state from a bay state data structure type, depending upon the candidate vehicle property;
and wherein said determining of best path route further includes updating the temporal occupancy state of each bay of said best path route in a bay state data structure type that depends upon the properties of said selected vehicle, with a bay state reflecting the time duration that the selected vehicle will pass through the bay.

28. The method according to claim 27 wherein said vehicle properties include (i) vehicle loaded with an object or (ii) vehicle unloaded and (iii) vehicle height.

29. The method according to any one of the preceding claims, wherein calculating said d starvation time complies with the following equation:
starvation time=(ETA−Now)−((n−1)*service time),
wherein
ETA−Now=equals said estimated time of arrival to said delivery bay minus current time,
(n−1)*service time equals said resource available time tag and wherein (n−1) equals a cycle number of said at least two resource service cycles.

30. A computerized delivery service provision method, comprising:
providing a plurality of vehicles and plurality of bays;
selecting vehicles of said plurality of vehicles for assignment to a resource;
said selecting of each vehicle with respect to a resource includes:
determining for said resource candidate vehicles of said plurality of vehicles that meet a vehicle candidacy criterion;
calculating hypothetical path routes, each including at least one path bay and delivery bay of said bays, associated with at least one of said candidate vehicles; giving rise to hypothetical path routes for the at least one of the candidate vehicles;
determining a best path route from among the hypothetical path routes and selecting a vehicle from the at least one of said candidate vehicles that is associated with the best path route,
wherein said selected vehicle will pass through the at least one path bay terminating at said delivery bay of said best path route for provisioning of the delivery service between the selected vehicle and the resource;
and wherein said best path route involves calculated starvation time, associated with the resource, which, compared to starvation times of any other hypothetical path routes associated with the resource, meets a starvation criterion.

31. The method according to claim 30, wherein each bay of said plurality of bays is associated with a bay state indicative of a series of temporal occupancy states of the bay and wherein the starvation time of each one of said best path route and said other hypothetical path routes are dependent upon the bay state of each of the bays of the route.

32. A computerized delivery service provision method, comprising:
providing a plurality of vehicles and plurality of bays;
selecting vehicles of said plurality of vehicles for assignment to resources, and for each resource per each of at least two resource service cycles;
said selecting of each vehicle with respect to a resource service cycle of said service cycles includes:
determining, for said resource service cycle, candidate vehicles of said plurality of vehicles that meet a vehicle candidacy criterion;
calculating at least one hypothetical path route associated with at least one of said candidate vehicles;
each hypothetical path route including path bays, of the plurality of bays, through which said candidate vehicle would hypothetically pass and terminate at a corresponding hypothetical Estimate Time of Arrival (ETA) in a delivery bay of said bays for hypothetically provisioning of a delivery service between the candidate vehicle and the resource at said resource service cycle, giving rise to hypothetical path routes for said candidate vehicles;
calculating hypothetical starvation times associated with said hypothetical path routes, each hypothetical starvation time, of said starvation times, defining a time interval, commencing from a resource service start time of said resource at said resource service cycle and terminating at the hypothetical ETA of hypothetical path route, of said hypothetical path routes, and during which the resource is assumed to hypothetically wait for the candidate vehicle that is associated with the hypothetical path route, for hypothetical provisioning of a delivery service at said resource service cycle;
determining a hypothetical path route from among said hypothetical path routes whose associated starvation time meets a starvation criterion and rendering the determined hypothetical path route as a best path route and selecting a vehicle from the at least one candidate vehicle associated with the best path route, for provisioning of the delivery service between the selected vehicle and the resource at said resource service cycle.

33. A computerized vehicle navigation method, comprising
(iv) providing a plurality of vehicles having only static sensing capacities operable to sense static surroundings associated with a plurality of bays and being devoid of dynamic sensing capacities of dynamic vehicles that are operable to utilize the plurality of bays;
(v) dynamically determining in respect of each bay of a plurality of bays a bay state indicative of a series of temporal occupancy states of the bay, each of said temporal occupancy states is composed of at least (i) vacant state and duration during which a vehicle of said vehicles may utilize said bay or (ii) occupied state and duration during which a vehicle of said vehicles utilize or will utilize said bay;
(vi) determining at least one path route for at least one of said vehicles, wherein each path route of said path routes includes a start bay, at least one path bays and an arrival bay, of said plurality of bays; said determining in respect of each path bay including selecting said path bay out of possible bays of said plurality of bays utilizing the temporal occupancy states of the bay states of said possible bays and according to a path route criterion, thereby facilitating a vehicle of said vehicles associated with the determined path route to utilize the bays of said determined path route based on only said static sensing capabilities.

34. The method according to claim 33, wherein said criterion stipulates that the vehicle Estimated Time of Arrival to said arrival bay is earlier than any other hypothesized path bays that start from said start bay and end at said arrival bay.

35. A computerized delivery service provision system, comprising
a plurality of vehicles configured to utilize a plurality of bays;
a processor and associated database configured to
(j) selecting vehicles of said plurality of vehicles for assignment to resources; said selecting of each vehicle with respect to a resource includes:
a. determining, for said resource, candidate vehicles of said plurality of vehicles that meet a vehicle candidacy criterion;
b. calculating at least one hypothetical path route associated with at least one of said candidate vehicles; each hypothetical path route including path bays, of the plurality of bays, through which said candidate vehicle would hypothetically pass and terminating at a corresponding hypothetical Estimate Time of Arrival (ETA) in a delivery bay of said bays, constituting an ETA of the hypothetical path route, for hypothetically provisioning of a delivery service between the candidate vehicle and the resource, giving rise to hypothetical path routes for said candidate vehicles;
c. calculating hypothetical starvation times associated with said hypothetical path routes, each hypothetical starvation time, of said starvation times, defining a time interval, commencing from a resource service start time of said resource and terminating at the hypothetical ETA of the hypothetical path route, of said hypothetical path routes, and during which the resource is assumed to hypothetically wait for the candidate vehicle that is associated with the hypothetical path route, for hypothetical provisioning of a delivery service;
d. determining a hypothetical path route from among said hypothetical path routes whose associated starvation time meets a starvation criterion and rendering the determined hypothetical path route as a best path route and selecting a vehicle from the at least one candidate vehicles associated with the best path route, for provisioning of the delivery service between the selected vehicle and the resource.

36. The system according to claim 35, wherein said processor includes an outside of vehicle processor and a vehicle processor associated with each of said vehicles.

37. The system according to claim 36 wherein said selecting, determining of (i)(a), calculating of (i) (b, calculating of (i) (c) and determining of (i) (d), are all performed by said outside of vehicle processor.

38. The system according to claim 36 wherein said at least part of said selecting, determining of (i)(a), calculating of (i) (b), calculating of (i) (c) and determining of (i) (d), are performed at least partially by at least one of said vehicle processors.

39. A machine-readable non-transitory memory tangibly embodying a program of instructions executable by a processor for executing the method of any one of the claims 1 to 29.
